(19) United States
(12) Patent Application Publication
(10) Pub. No.: US 2023/0308334 A1
(43) Pub. Date: Sep. 28, 2023

(54) SIGNAL TRANSMISSION METHOD AND APPARATUS

(71) Applicant: HUAWEI TECHNOLOGIES CO., LTD., Shenzhen (CN)

(72) Inventors: Huang HUANG, Shenzhen (CN); Qianli MA, Chengdu (CN)

(21) Appl. No.: 18/326,329

(22) Filed: May 31, 2023

Related U.S. Application Data
(63) Continuation of application No. PCT/CN2021/138262, filed on Dec. 15, 2021.

(30) Foreign Application Priority Data
Dec. 15, 2020 (CN) 202011483091.0

(51) Int. Cl. H04L 27/26; H04L 25/03

(52) U.S. Cl. CPC H04L 27/2634; H04L 27/265; H04L 25/03828

(57) ABSTRACT

This application provides methods and apparatuses for signal transmission. An example method includes: a transmit end obtains 2M first to-be-sent signals, then performs first generalized Fourier transform based on the 2M first to-be-sent signals, to obtain N second to-be-sent signals, then performs spectrum shaping based on the N second to-be-sent signals, to obtain N third to-be-sent signals, and then performs first inverse generalized Fourier transform based on the N third to-be-sent signals, to obtain and send a first sent signal.

### CROSS-REFERENCE TO RELATED APPLICATIONS

This application is a continuation of International Application No. PCT/CN2021/138262, filed on Dec. 15, 2021, which claims priority to Chinese Patent Application No. 202011483091.0, filed on Dec. 15, 2020. The disclosures of the aforementioned applications are hereby incorporated by reference in their entireties.

### TECHNICAL FIELD

This application relates to the field of wireless communication technologies, and in particular, to a signal transmission method and apparatus.

### BACKGROUND

Discrete Fourier transform spreading orthogonal frequency division multiplexing (DFT-s-OFDM) is a signal generation manner of an uplink in a long term evolution (LTE). Because in the DFT-s-OFDM, before a process of conventional orthogonal frequency division multiplexing (OFDM) processing, additional discrete Fourier transform (DFT) processing is performed, the DFT-s-OFDM is also referred to as a linear precoding OFDM technology. The DFT-s-OFDM is essentially a single carrier. Therefore, compared with conventional OFDM, a peak-to-average power ratio (PAPR) in the DFT-s-OFDM is low. This can improve power transmission efficiency of a terminal, prolong a battery lifespan, and reduce terminal costs.

Single carrier offset quadrature amplitude modulation (SC-OQAM) is essentially that a real part and an imaginary part of a complex signal are separated and then pass through a filter, and has a lower PAPR than a conventional complex implementation method. However, an odd-order filter is used in existing SC-OQAM, and frequency domain resources in a currently commonly used implementation method are an even multiple of frequency domain resources. Therefore, a conventional filter processing method is uneasy to be compatible with scheduling of the frequency domain resources in the currently commonly used implementation method.

### SUMMARY

This application provides a signal transmission method and apparatus, to resolve, on a premise that no intersymbol interference (ISI) is introduced, how to be compatible with scheduling of an even multiple of frequency domain resources in a currently commonly used implementation method when a response of a filter in an SC-OQAM system has an odd quantity of points.

To achieve the foregoing objective, the following technical solutions are used in embodiments of this application.

According to a first aspect, this application provides a signal transmission method. First, a transmit end obtains 2M first to-be-sent signals. Then, the transmit end performs first generalized Fourier transform based on the 2M first to-be-sent signals, to obtain N second to-be-sent signals. Then, the transmit end performs spectrum shaping based on the N second to-be-sent signals, to obtain N third to-be-sent signals. Then, the transmit end performs first inverse generalized Fourier transform based on the N third to-be-sent signals, to obtain and send a first sent signal. M and N are positive integers, and 2M is greater than or equal to N.

It can be learned that, on a premise that no ISI is introduced, an even-order filter is obtained by performing offset sampling on an odd-order filter, so that the even-order filter is used to be compatible with scheduling of an even multiple of frequency domain resources in a currently commonly used implementation method. This facilitates frequency domain resource scheduling, and resolves a conventional-technology problem of being incompatible with a resource scheduling manner in an existing protocol when a response of a filter has an odd quantity of points. In a possible implementation, the first generalized Fourier transform includes the following steps: The transmit end performs first phase shift based on the first to-be-sent signal, to obtain a fourth to-be-sent signal. Then, the transmit end performs discrete Fourier transform (DFT) or fast Fourier transform (FFT) based on the fourth to-be-sent signal, to obtain the second to-be-sent signal.

In a possible implementation, a value of the first phase shift satisfies the following formula:

$${e}^{\frac{- j π m α}{M}} ,$$

where α is 0.5 or −0.5, m∈[m₀, m₀+2M−1], m and m₀ are integers, M is a positive integer, and j=\sqrt{−1}.

In a possible implementation, the first inverse generalized Fourier transform includes the following steps: The transmit end performs inverse discrete Fourier transform (IDFT) or inverse fast Fourier transform (IFFT) based on the third to-be-sent signal, to obtain a fifth to-be-sent signal. Then, the transmit end performs second phase shift based on the fifth to-be-sent signal, to obtain the first sent signal.

In a possible implementation, a value of the second phase shift satisfies the following formula:

$${e}^{\frac{j π m α}{M}} ,$$

a value of the second phase shift is equal to 1, where
α is 0.5 or −0.5, m∈[m₀, m₀+2M−1], m and m₀ are integers, M is a positive integer, and j=\sqrt{−1}.

In a possible implementation, a value of m₀ is any one of 0, −M, or −M+1.

In a possible implementation, in the 2M first to-be-sent signals, a first to-be-sent signal with an odd sequence number includes only a real part signal, and a first to-be-sent signal with an even sequence number includes only an imaginary part signal. Alternatively, in the 2M first to-be-sent signals, a first to-be-sent signal with an even sequence number includes only a real part signal, and a first to-be-sent signal with an odd sequence number includes only an imaginary part signal. Alternatively, all the 2M first to-be-sent signals include only real part signals. Alternatively, all the 2M first to-be-sent signals include only imaginary part signals.

In a possible implementation, the spectrum shaping includes the following steps: The transmit end performs frequency domain shaping on the N second to-be-sent signals by using a filter whose filter length is N; multiplies, by a spectrum shaping coefficient A*P(k), the N second to-be-sent signals obtained through the frequency domain shaping, where k ∈ [k₀, k₀+N−1], k is a sequence number of a subcarrier, k₀ is a sequence number of a start location of the subcarrier, and A is a complex constant; and then, obtains the N third to-be-sent signals.

In a possible implementation, when all the 2M first to-be-sent signals include only real part signals, or when all the 2M first to-be-sent signals include only imaginary part signals, symmetry of P(k) is related to a value of α, and a relationship is shown as follows:

When α=0.5, N is an even number, M is an even number,

$${k}_{0} = - \frac{N - M}{2} + lM ,$$

and P(k) is conjugate symmetric about

$$k = - \frac{1 - M}{2} + lM ;$$

or N is an odd number, M is an odd number,

$${k}_{0} = - \frac{N - M}{2} + lM ,$$

and P(k) is conjugate symmetric about

$$k = - \frac{1 - M}{2} + lM .$$

When α=−0.5, N is an even number, M is an even number,

$${k}_{0} = - \frac{N - M}{2} - 1 + lM ,$$

and P(k) is conjugate symmetric about

$$k = \frac{1 + M}{2} + lM ;$$

or N is an odd number, M is an odd number,

$${k}_{0} = - \frac{N - M}{2} - 1 + lM ,$$

and P(k) is conjugate symmetric about

$$k = \frac{1 + M}{2} + lM .$$

l is an integer.

In other words, when all the 2M first to-be-sent signals include only real part signals, or when all the 2M first to-be-sent signals include only imaginary part signals, parity of N and parity of M are the same, that is, N and M are both odd numbers or even numbers.

In a possible implementation, when in the 2M first to-be-sent signals, a first to-be-sent signal with an odd sequence number includes only a real part signal, and a first to-be-sent signal with an even sequence number includes only an imaginary part signal, or when in the 2M first to-be-sent signals, a first to-be-sent signal with an even sequence number includes only a real part signal, and a first to-be-sent signal with an odd sequence number includes only an imaginary part signal, symmetry of P(k) is related to a value of α, and a relationship is shown as follows:

When α=0.5, N is an even number,

$${k}_{0} = - \frac{N}{2} + lM ,$$

and P(k) is conjugate symmetric about

$$k = - \frac{1}{2} + lM .$$

When α=−0.5, N is an even number,

$${k}_{0} = - \frac{N}{2} - 1 + lM ,$$

and P(k) is conjugate symmetric about k=½+lM. l is an integer.

According to a second aspect, this application provides a signal transmission method. First, a receive end obtains N first received signals. Then, the receive end performs second generalized Fourier transform based on the N first received signals, to obtain N second received signals. Then, the receive end performs equalization based on the second received signal, to obtain a third received signal. Then, the receive end performs oversampling based on the third received signal, to obtain 2M fourth received signals. Then, the receive end performs second inverse generalized Fourier transform based on the 2M fourth received signals, to obtain a fifth received signal. M and N are positive integers, and 2M is greater than or equal to N.

It can be learned that, on a premise that no ISI is introduced, an even-order filter is obtained by performing offset sampling on an odd-order filter, so that the even-order filter is used to be compatible with scheduling of an even multiple of frequency domain resources in a currently commonly used implementation method. This facilitates frequency domain resource scheduling, and resolves a conventional-technology problem of being incompatible with a resource scheduling manner in an existing protocol when a response of a filter has an odd quantity of points. In a possible implementation, the second generalized Fourier transform includes the following steps: The receive end performs third phase shift based on the first received signal, to obtain a sixth received signal. Then, the receive end performs discrete Fourier transform DFT or fast Fourier transform FFT based on the sixth received signal, to obtain the second received signal.

In a possible implementation, a value of the third phase shift satisfies the following formula:

$${e}^{\frac{- j π m α}{M}} ,$$

or a value of the third phase shift is equal to 1, where α is 0.5 or −0.5, m∈[m₀, m₀+2M−1], m and m₀ are integers, M is a positive integer, and j=\sqrt{−1}.

In a possible implementation, the second inverse generalized Fourier transform includes the following steps: The receive end performs inverse discrete Fourier transform IDFT or inverse fast Fourier transform IFFT based on the fourth received signal, to obtain a seventh received signal. Then, the receive end performs fourth phase shift based on the seventh received signal, to obtain the fifth received signal.

In a possible implementation, a value of the fourth phase shift satisfies the following formula:

$${e}^{\frac{j π m α}{M}} ,$$

where α is 0.5 or −0.5, m∈[m₀, m₀+2M−1], m and m₀ are integers, M is a positive integer, and j=\sqrt{−1}.

In a possible implementation, a value of m₀ is any one of 0, −M, or −M+1.

In a possible implementation, a manner in which the receive end performs equalization on the second received signal includes at least one of the following: a least squares method or a minimum mean-square error criterion.

According to a third aspect, this application provides a signal transmission apparatus, configured to perform the method in any one of the possible implementations of the first aspect. The apparatus may be the transmit end in any one of the possible implementations of the first aspect, or a module applied to the transmit end, for example, a chip or a chip system. The apparatus includes a corresponding module, unit, means, or the like for implementing the method performed by the transmit end in any one of the possible implementations of the first aspect. The module, unit, or means may be implemented by hardware, by software, or by hardware by executing corresponding software. The hardware or software includes one or more modules or units corresponding to a function performed by the transmit end in any one of the possible implementations of the first aspect.

The apparatus includes a processing unit and a transceiver unit.

The transceiver unit is configured to obtain 2M first to-be-sent signals.

The processing unit is configured to perform first generalized Fourier transform based on the 2M first to-be-sent signals, to obtain N second to-be-sent signals.

The processing unit is further configured to perform spectrum shaping based on the N second to-be-sent signals, to obtain N third to-be-sent signals.

The processing unit is further configured to perform first inverse generalized Fourier transform based on the N third to-be-sent signals, to obtain a first sent signal.

The transceiver unit is further configured to send the first sent signal.

M and N are positive integers, and 2M is greater than or equal to N. In a possible implementation, the first generalized Fourier transform includes the following steps: The processing unit performs first phase shift based on the first to-be-sent signal, to obtain a fourth to-be-sent signal. Then, the processing unit performs discrete Fourier transform (DFT) or fast Fourier transform (FFT) based on the fourth to-be-sent signal, to obtain the second to-be-sent signal.

In a possible implementation, a value of the first phase shift satisfies the following formula:

$${e}^{\frac{- j π m α}{M}} ,$$

where α is 0.5 or −0.5, m∈[m₀, m₀+2M−1], m and m₀ are integers, M is a positive integer, and j=\sqrt{−1}.

In a possible implementation, the first inverse generalized Fourier transform includes the following steps: The processing unit performs inverse discrete Fourier transform (IDFT) or inverse fast Fourier transform (IFFT) based on the third to-be-sent signal, to obtain a fifth to-be-sent signal. Then, the processing unit performs second phase shift based on the fifth to-be-sent signal, to obtain the first sent signal.

In a possible implementation, a value of the second phase shift satisfies the following formula:

$${e}^{\frac{j π m α}{M}} ,$$

or a value of the second phase shift is equal to 1, where
α is 0.5 or −0.5, m∈[m₀, m₀+2M−1], m and m₀ are integers, M is a positive integer, and j=\sqrt{−1}.

In a possible implementation, a value of m₀ is any one of 0, −M, or −M+1.

In a possible implementation, in the 2M first to-be-sent signals, a first to-be-sent signal with an odd sequence number includes only a real part signal, and a first to-be-sent signal with an even sequence number includes only an imaginary part signal. Alternatively, in the 2M first to-be-sent signals, a first to-be-sent signal with an even sequence number includes only a real part signal, and a first to-be-sent signal with an odd sequence number includes only an imaginary part signal. Alternatively, all the 2M first to-be-sent signals include only real part signals. Alternatively, all the 2M first to-be-sent signals include only imaginary part signals.

In a possible implementation, the spectrum shaping includes the following steps: The processing unit performs frequency domain shaping on the N second to-be-sent signals by using a filter whose filter length is N; multiplies, by a spectrum shaping coefficient A*P(k), the N second to-be-sent signals obtained through the frequency domain shaping, where k ∈ [k₀, k₀+N−1], k is a sequence number of a subcarrier, k₀ is a sequence number of a start location of the subcarrier, and A is a complex constant; and then, obtains the N third to-be-sent signals.

In a possible implementation, when all the 2M first to-be-sent signals include only real part signals, or when all the 2M first to-be-sent signals include only imaginary part signals, symmetry of P(k) is related to a value of α, and a relationship is shown as follows:

When α=0.5, N is an even number, M is an even number,

$${k}_{0} = - \frac{N - M}{2} + lM ,$$

and P(k) is conjugate symmetric about

$$k = - \frac{1 - M}{2} + lM ;$$

or N is an odd number, M is an odd number,

$${k}_{0} = - \frac{N - M}{2} + lM ,$$

and P(k) is conjugate symmetric about

$$k = - \frac{1 - M}{2} + lM .$$

When α=−0.5, N is an even number, M is an even number,

$${k}_{0} = - \frac{N - M}{2} - 1 + lM ,$$

and P(k) is conjugate symmetric about

$$k = \frac{1 + M}{2} + lM ;$$

or N is an odd number, M is an odd number,

$${k}_{0} = - \frac{N - M}{2} - 1 + lM ,$$

and P(k) is conjugate symmetric about

$$k = \frac{1 + M}{2} + lM .$$

l is an integer.

In other words, when all the 2M first to-be-sent signals include only real part signals, or when all the 2M first to-be-sent signals include only imaginary part signals, parity of N and parity of M are the same, that is, N and M are both odd numbers or even numbers.

In a possible implementation, when in the 2M first to-be-sent signals, a first to-be-sent signal with an odd sequence number includes only a real part signal, and a first to-be-sent signal with an even sequence number includes only an imaginary part signal, or when in the 2M first to-be-sent signals, a first to-be-sent signal with an even sequence number includes only a real part signal, and a first to-be-sent signal with an odd sequence number includes only an imaginary part signal, symmetry of P(k) is related to a value of α, and a relationship is shown as follows:

When α=0.5, N is an even number,

$${k}_{0} = - \frac{N}{2} + lM ,$$

and P(k) is conjugate symmetric about k=−½+lM.

When α=−0.5, N is an even number,

$${k}_{0} = - \frac{N}{2} - 1 + lM ,$$

and P(k) is conjugate symmetric about k=½+lM. l is an integer.

According to a fourth aspect, this application provides a signal transmission apparatus, configured to perform the method in any one of the possible implementations of the second aspect. The apparatus may be the receive end in any one of the possible implementations of the second aspect, or a module applied to the receive end, for example, a chip or a chip system. The apparatus includes a corresponding module, unit, means, or the like for implementing the method performed by the receive end in any one of the possible implementations of the first aspect. The module, unit, or means may be implemented by hardware, by software, or by hardware by executing corresponding software. The hardware or software includes one or more modules or units corresponding to a function performed by the receive end in any one of the possible implementations of the first aspect.

The apparatus includes a processing unit and a transceiver unit.

The transceiver unit is configured to obtain N first received signals.

The processing unit is configured to perform second generalized Fourier transform based on the N first received signals, to obtain N second received signals.

The processing unit is further configured to perform equalization based on the second received signal, to obtain a third received signal.

The processing unit is further configured to perform oversampling based on the third received signal, to obtain 2M fourth received signals.

The processing unit is further configured to perform second inverse generalized Fourier transform based on the 2M fourth received signals, to obtain a fifth received signal.

M and N are positive integers, and 2M is greater than or equal to N. In a possible implementation, the second generalized Fourier transform includes the following steps: The processing unit performs third phase shift based on the first received signal, to obtain a sixth received signal. Then, the processing unit performs discrete Fourier transform DFT or fast Fourier transform FFT based on the sixth received signal, to obtain the second received signal.

In a possible implementation, a value of the third phase shift satisfies the following formula:

$${e}^{\frac{- j π m α}{M}} ,$$

or a value of the third phase shift is equal to 1, where α is 0.5 or −0.5, m∈[m₀, m₀+2M−1], m and m₀ are integers, M is a positive integer, and j=\sqrt{−1}.

In a possible implementation, the second inverse generalized Fourier transform includes the following steps: The processing unit performs inverse discrete Fourier transform IDFT or inverse fast Fourier transform IFFT based on the fourth received signal, to obtain a seventh received signal. Then, the processing unit performs fourth phase shift based on the seventh received signal, to obtain the fifth received signal.

In a possible implementation, a value of the fourth phase shift satisfies the following formula:

$${e}^{\frac{j π m α}{M}} ,$$

where α is 0.5 or −0.5, m∈[m₀, m₀+2M−1], m and m₀ are integers, M is a positive integer, and j=\sqrt{−1}.

In a possible implementation, a value of m₀ is any one of 0, −M, or −M+1.

In a possible implementation, a manner in which the processing unit performs equalization on the second received signal includes at least one of the following: a least squares method or a minimum mean-square error criterion.

According to a fifth aspect, an embodiment of this application provides a signal transmission apparatus, including a processor and a memory. The memory is configured to store computer instructions. When the processor executes the instructions, the apparatus is enabled to perform the method in any one of the foregoing aspects. The communication apparatus may be the transmit end in any one of the first aspect or the possible implementations of the first aspect, or a chip that implements a function of the transmit end. Alternatively, the communication apparatus may be the receive end in any one of the second aspect or the possible implementations of the second aspect, or a chip that implements a function of the receive end.

According to a sixth aspect, an embodiment of this application provides a signal transmission apparatus, including a processor. The processor is configured to: after being coupled to a memory and reading instructions in the memory, perform the method according to any one of the foregoing aspects according to the instructions. The communication apparatus may be the transmit end in any one of the first aspect or the possible implementations of the first aspect, or a chip that implements a function of the transmit end. Alternatively, the communication apparatus may be the receive end in any one of the second aspect or the possible implementations of the second aspect, or a chip that implements a function of the receive end.

According to a seventh aspect, an embodiment of this application provides a communication apparatus, including a logic circuit and an input/output interface. The input/output interface is configured to communicate with a module outside the communication apparatus. For example, the input/output interface is configured to input a first to-be-sent signal and output a first sent signal. The logic circuit is configured to run a computer program or instructions, and perform the method according to any one of claims 1 to 10 based on the first to-be-sent signal, to obtain the first sent signal. The communication apparatus may be a chip system. The chip system may include a chip, or may include a chip and another discrete component. The chip may be a chip that implements a function of the transmit end in any one of the first aspect or the possible implementations of the first aspect.

According to an eighth aspect, an embodiment of this application provides a communication apparatus, including a logic circuit and an input/output interface. The input/output interface is configured to communicate with a module outside the communication apparatus. For example, the input/output interface is configured to input a first received signal and/or a first received signal. The logic circuit is configured to run a computer program or instructions, and perform the method according to any one of claims 11 to 17 based on the first received signal, to obtain the fifth received signal. The communication apparatus may be a chip system. The chip system may include a chip, or may include a chip and another discrete component. The chip may be a chip that implements a function of the receive end in any one of the second aspect or the possible implementations of the second aspect.

According to a ninth aspect, an embodiment of this application provides a computer-readable storage medium. The computer-readable storage medium stores instructions. When the instructions run on a computer, the computer is enabled to perform the signal transmission method in any one of the foregoing aspects.

According to a tenth aspect, an embodiment of this application provides a computer program product including instructions. When the computer program product runs on a computer, the computer is enabled to perform the signal transmission method in any one of the foregoing aspects.

According to an eleventh aspect, an embodiment of this application provides a circuit system. The circuit system includes a processing circuit, and the processing circuit is configured to perform the signal transmission method according to any one of the foregoing aspects.

According to a twelfth aspect, an embodiment of this application provides a communication system. The communication system includes the receive end and the transmit end in any of the foregoing aspects.

For technical effects brought by any implementation of the third aspect to the twelfth aspect, refer to beneficial effects in the corresponding method provided above. Details are not described herein again.

### BRIEF DESCRIPTION OF DRAWINGS

FIG. 1 is a schematic diagram of a communication system according to an embodiment of this application;

FIG. 2 is a schematic diagram of a peak-to-average power ratio according to an embodiment of this application;

FIG. 3 is a schematic diagram of a system implementation procedure in DFT-s-OFDM according to an embodiment of this application;

FIG. 4 is a schematic diagram of a time domain implementation procedure at a transmit end in SC-OQAM according to an embodiment of this application;

FIG. 5 is a schematic diagram of a time domain implementation procedure at a transmit end in SC-QAM according to an embodiment of this application;

FIG. 6a is a schematic diagram of a waveform in SC-QAM according to an embodiment of this application;

FIG. 6b is a schematic diagram of a waveform that passes through an SC-QAM filter according to an embodiment of this application;

FIG. 7a is a schematic diagram of a waveform in SC-OQAM according to an embodiment of this application;

FIG. 7b is a schematic diagram of a waveform that passes through an SC-OQAM filter according to an embodiment of this application;

FIG. 7c is a schematic diagram of a frequency response of an SC-OQAM filter according to an embodiment of this application;

FIG. 8 is a schematic diagram of a frequency domain implementation procedure at a transmit end in SC-OQAM according to an embodiment of this application;

FIG. 9 is a schematic diagram of frequency domain shaping in DFT-S-OFDM according to an embodiment of this application;

FIG. 10 is a schematic diagram of a signal transmission procedure at a transmit end according to an embodiment of this application;

FIG. 11 is a schematic diagram of a signal transmission procedure at a receive end according to an embodiment of this application;

FIG. 12 is a schematic diagram of a signal transmission procedure at a transmit end according to an embodiment of this application;

FIG. 13 is a schematic diagram of a signal transmission procedure at a receive end according to an embodiment of this application;

FIG. 14 is a schematic diagram of a signal transmission procedure at a transmit end according to an embodiment of this application;

FIG. 15 is a schematic diagram of a signal transmission procedure at a receive end according to an embodiment of this application;

FIG. 16 is a schematic diagram of a signal transmission apparatus according to an embodiment of this application;

FIG. 17 is a schematic diagram of a structure of a terminal device according to an embodiment of this application; and

FIG. 18 is a schematic diagram of a structure of a chip according to an embodiment of this application.

### DESCRIPTION OF EMBODIMENTS

In the specification and accompanying drawings of this application, the terms “first”, “second”, and the like are used to distinguish between different objects or different processing on a same object, but are not used to describe a specific order of the objects. In addition, the terms “comprise” and “have” and any variations thereof referred to in the descriptions of this application are intended to cover non-exclusive inclusions. For example, a process, a method, a system, a product, or a device that includes a series of steps or units is not limited to the listed steps or units, but optionally, further includes other steps or units that are not listed, or optionally, further includes other steps or units inherent to the process, the method, the product, or the device. In embodiments of this application, “a plurality of” includes two or more, and a “system” and a “network” may be mutually replaced. In the embodiments of this application, words such as “exemplary” or “for example” are used to represent an example, illustration, or a description. Any embodiment or design solution described as “exemplary” or “for example” in the embodiments of this application should not be interpreted as being more preferred or advantageous than another embodiment or design solution. Specifically, use of the words “exemplary” or “for example” is intended to present a related concept in a concrete manner.

A communication method provided in the embodiments of this application may be applied to various communication systems, for example, a satellite communication system, an internet of things (IoT) system, a narrowband internet of things (NB-IoT) system, a global system for mobile communications (GSM) system, an enhanced data rate for GSM evolution (EDGE) system, a wideband code division multiple access (WCDMA) system, a code division multiple access 2000 (CDMA2000) system, a time division-synchronous code division multiple access (TD-SCDMA) system, a long term evolution (LTE) system, a fifth generation (5G) communication system, such as 5G new radio (NR), and three application scenarios of the 5G mobile communication system: enhanced mobile broadband (eMBB), ultra-reliable and low-latency communications (uRLLC), and mass machine type communications (mMTC), a device-to-device (D2D) communication system, a machine-to-machine (M2M) communication system, an internet of vehicles communication system, or another or future communication system. This is not specifically limited in the embodiments of this application.

The following describes the embodiments of this application with reference to the accompanying drawings in the embodiments of this application. Terms used in DESCRIPTION OF EMBODIMENTS of this application are merely used to explain specific embodiments of this application, but are not intended to limit this application.

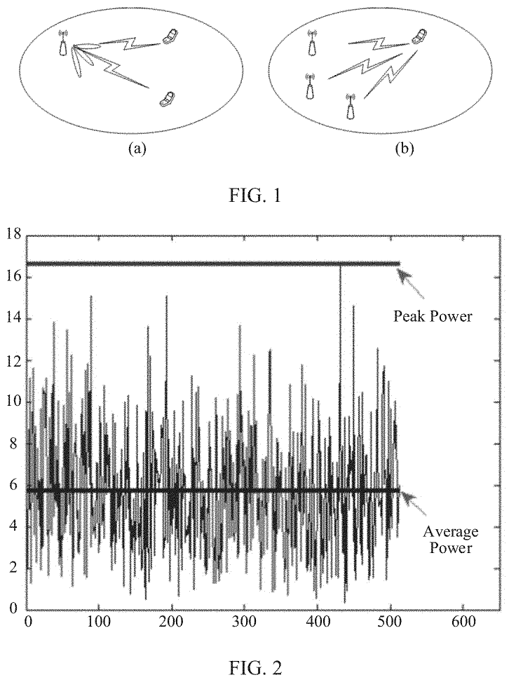

For ease of understanding of the embodiments of this application, an application scenario used in the embodiments of this application is described by using a network architecture shown in FIG. 1. The network architecture may be applied to the foregoing various communication systems. A communication system shown in FIG. 1 includes a network device and a terminal. In this application, both a transmit end and a receive end may be a network device or a terminal. This is not limited in this application. The network device and the terminal may perform wireless communication by using a resource. Types and quantities of network devices and the terminal devices are not limited in the embodiments of this application. As shown in FIG. 1a, there may be one or more terminal devices. As shown in FIG. 1b, there may also be one or more network devices. The resource herein may include one or more of a time domain resource, a frequency domain resource, a code domain resource, and a space domain resource. In addition, this application is also applicable to a system in which a terminal communicates with a terminal, and is also applicable to a system in which a network device communicates with a network device.

The terminal includes a device that provides voice and/or data connectivity for a user. Specifically, the terminal includes a device that provides voice for a user, includes a device that provides data connectivity for a user, or includes a device that provides voice and data connectivity for a user. For example, the terminal may include a handheld device having a wireless connection function, or a processing device connected to a wireless modem. The terminal device may communicate with a core network by using a radio access network (RAN), and exchange voice or data with the RAN, or interact with the RAN to exchange voice and data. The terminal device may include user equipment (UE), a wireless terminal device, a mobile terminal device, a device-to-device communication (D2D) terminal device, a vehicle to everything (V2X) terminal device, a machine-to-machine/machine-type communications (M2M/MTC) terminal device, an internet of things (IoT) terminal device, a light terminal device (light UE), a subscriber unit, a subscriber station, a mobile station, a remote station, an access point (AP), a remote terminal, an access terminal, a user terminal, a user agent, an unmanned aerial vehicle, a user device, or the like. For example, the terminal device may include a mobile phone (or referred to as a “cellular” phone), a computer having a mobile terminal device, a portable, pocket-sized, hand-held, or computer-built-in mobile device, or the like, such as a personal communication service (PCS) phone, a cordless phone, a session initiation protocol (SIP) phone, a wireless local loop (WLL) station, a personal digital assistant (PDA), and other equipment. The terminal device further includes a limited device, for example, a device with relatively low power consumption, a device with a limited storage capability, or a device with a limited computing capability, such as an information sensing device including a bar code, radio frequency identification (RFID), a sensor, a global positioning system (GPS), a laser scanner, and the like.

As an example instead of a limitation, in the embodiments of this application, the terminal may alternatively be a wearable device. The wearable device may also be referred to as a wearable intelligent device, an intelligent wearable device, or the like, and is a general term for a wearable device, such as glasses, gloves, watches, clothes, and shoes, that is intelligently designed and developed for daily wear by using a wearable technology. The wearable device is a portable device that is directly worn on a body or integrated into clothes or accessories of a user. The wearable device is not only a hardware device, but also a powerful function implemented through software support, data interaction, and cloud interaction. In a broad sense, the wearable intelligent device has full functions and a large size, can implement all or some of the functions without relying on a smartphone, for example, a smart watch or smart glasses, focuses only on a certain type of application functions, and needs to be used in cooperation with another device such as a smartphone, such as a smart bracelet, a smart helmet, and smart jewelry for physical sign monitoring.

The various terminals described above may be considered as a vehicle-mounted terminal if being located in a vehicle (for example, placed inside a vehicle or mounted inside a vehicle). A vehicle-mounted terminal device is also referred to as an on-board unit (OBU).

In the embodiments of this application, the terminal may further include a relay. Alternatively, it may be understood that all devices that can perform data communication with a base station may be considered as terminal devices.

In the embodiments of this application, an apparatus configured to implement a function of the terminal may be a terminal, or may be an apparatus that can support the terminal device in implementing the function, for example, a chip system. The apparatus may be mounted inside the terminal. In the embodiments of this application, the chip system may include a chip, or may include a chip and another discrete component. In the technical solutions provided in the embodiments of this application, an example in which an apparatus configured to implement a function of the terminal is a terminal is used to describe the technical solutions provided in the embodiments of this application.

A network device, for example, including an access network (AN) device, such as a base station (for example, an access point), may be a device that communicates with a wireless terminal device over an air interface by using one or more cells in an access network. Alternatively, for example, a network device in a vehicle-to-everything (V2X) technology is a road side unit (RSU). The base station may be configured to perform mutual conversion between a received over-the-air frame and an IP packet, and serve as a router between the terminal device and a remaining part of the access network. The remaining part of the access network may include an IP network. The RSU may be a fixed infrastructure entity supporting a V2X application, and may exchange a message with another entity supporting the V2X application. The network device may further coordinate attribute management of the air interface. For example, the network device may include an evolved base station (NodeB, eNB, or e-NodeB, evolved Node B) in a long term evolution (LTE) system or a long term evolution-advanced (LTE-A) system, may include a next generation node B (gNB) in a 5th generation mobile communication technology (5G) NR system (also referred to as an NR system for short), may include a centralized unit (CU) and a distributed unit (DU) in a cloud access network (Cloud RAN) system, or may be an apparatus that carries a function of a network device in a future communication system. This is not limited in the embodiments of this application.

The network device may further include a core network device. For example, the core network device includes an access and mobility management function (AMF), a user plane function (UPF), or the like.

Alternatively, the network device may be an apparatus that carries a function of the network device in device-to-device (D2D) communication, machine-to-machine (M2M) communication, an internet of vehicles, an unmanned aerial vehicle system, or a satellite communication system.

It should be noted that only manners of communication between some network elements are listed above. Other network elements may also communicate with each other in some connection manners. Details are not described herein again in the embodiments of this application.

The system architecture and the service scenario described in the embodiments of this application are intended to describe the technical solutions in the embodiments of this application more clearly, but do not constitute a limitation on the technical solutions provided in the embodiments of this application. A person of ordinary skill in the art may know that with evolution of a network architecture and emergence of a new service scenario, the technical solutions provided in the embodiments of this application are also applicable to similar technical problems.

To facilitate understanding of the embodiments of this application, the following explains and describes some terms of the embodiments of this application, to facilitate understanding by a person skilled in the art.

(1) Peak-to-average power ratio (PAPR):

A radio signal is a sine wave with a constantly changing amplitude in time domain. The amplitude is not constant. A peak signal amplitude in one period is different from that in another period. Therefore, an average power and a peak power in each period are different. A peak power is a maximum transient power that occurs with a certain probability over a long period of time, and the probability is usually 0.01% (i.e. 10\hat{ }−4). A ratio of the peak power with this probability to a total average power of a system is a peak-to-average power ratio.

There are two factors that affect the peak-to-average power ratio of the system:
1) a peak-to-average power ratio of a baseband signal (for example, a peak-to-average power of a 1024-QAM modulated baseband signal is high, and peak-to-average powers of QPSK modulated and BPSK modulated baseband signals are 1); and
2) a peak-to-average power ratio (for example, 10*log N in OFDM) brought by multi-carrier power superposition.

A high PAPR results in non-linear distortion of a signal, obvious spread spectrum interference and in-band signal distortion, and system performance reduction. A power of a signal in a wireless communication system needs to be amplified if the signal is to be sent far away. Due to limitations of technologies and costs, a power amplifier usually performs linear amplification only in one range, and signal distortion is caused outside the range. For example, a microphone used for singing can normally amplify a person's voice when a person normally talks. Sound becomes strange and harsh when the person shouts. Signal distortion causes a receive end to unable to correctly parse a signal.

(2) Discrete Fourier transform spreading orthogonal frequency division multiplexing (DFT-s-OFDM):

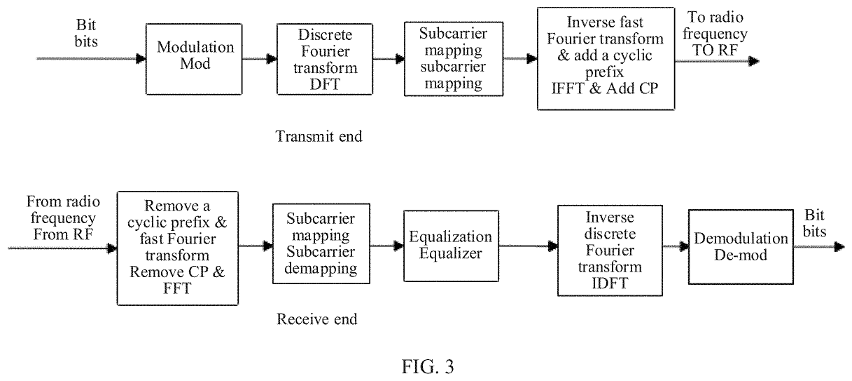

FIG. 3 is a schematic diagram of an implementation procedure of a DFT-s-OFDM system. The DFT-s-OFDM is a signal generation manner of an uplink in a long term evolution (LTE). Because in the DFT-s-OFDM, before a process of conventional orthogonal frequency division multiplexing (OFDM) processing, additional discrete Fourier transform (DFT) processing is performed, the DFT-s-OFDM is also referred to as a linear precoding OFDM technology. The DFT-s-OFDM is essentially a single carrier. Therefore, compared with conventional OFDM, a peak-to-average power ratio (PAPR) in the DFT-s-OFDM is low. This can improve power transmission efficiency of a terminal, prolong a battery lifespan, and reduce terminal costs.

(3) Single-carrier offset quadrature amplitude modulation (SC-OQAM) and single-carrier quadrature amplitude modulation (SC-QAM):

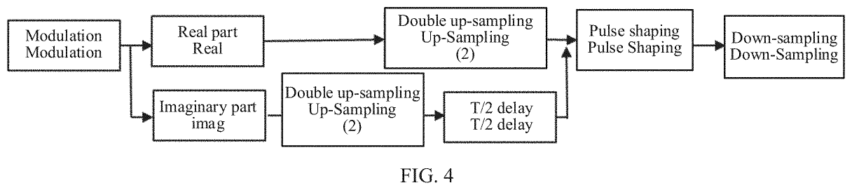

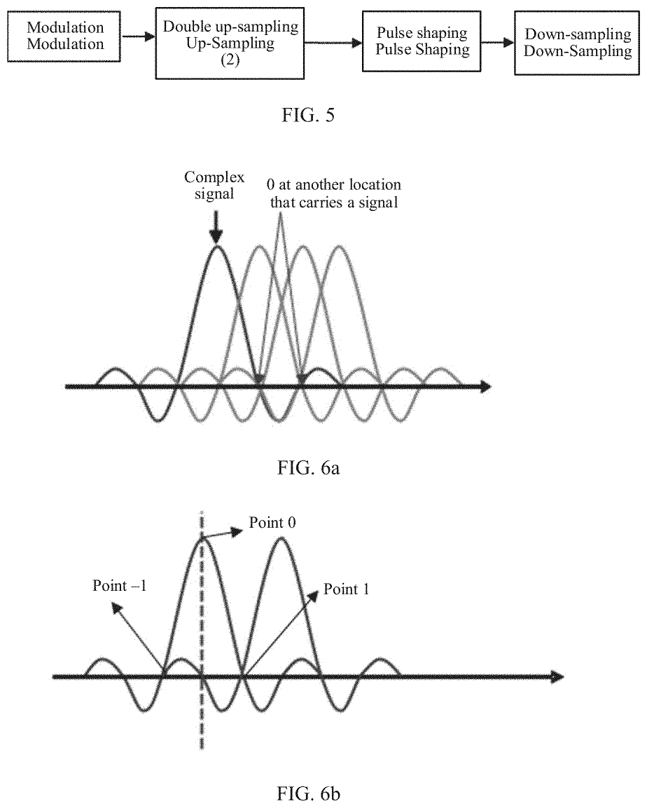

FIG. 4 is a schematic diagram of a time domain implementation procedure at a transmit end in SC-OQAM. FIG. 5 is a schematic diagram of a time domain implementation procedure of at a transmit end in SC-QAM. It can be learned by comparing the two flowcharts that in the SC-OQAM, separation of a real part and an imaginary part of a complex-modulated signal is added, and then, a T/2 delay is added to one path of signals. Other implementation steps are the same as those in the SC-QAM.

The SC-QAM carries a complex signal (such as a QAM signal). A root raised cosine (RCC) waveform is used as an example. As shown in FIG. 6a, an SC-QAM waveform is complex orthogonal. Herein, a concept of being complex orthogonal is that an SC-QAM waveform carries a complex signal, and the waveform is 0 at a sampling location of a signal carried by a next waveform. In this case, an orthogonality relationship exists between the current waveform and the next waveform carrying the signal.

When the SC-QAM waveform is to be implemented, as shown in FIG. 5, a time domain shaping filter, that is, pulse shaping in the figure, is needed. For the SC-QAM, the filter needs to meet two conditions: There is an odd quantity of non-zero elements, and the filter has symmetry, to ensure that ISI of a pure real part or a pure imaginary part is 0. As shown in FIG. 6b, FIG. 6b shows two SC-QAM signals obtained through pulse shaping. A prominent feature is that a filter used for pulse shaping is symmetric, and signal energy is strongest at a location of a point 0. Therefore, the filter has an odd quantity of points and is symmetric. To ensure that the ISI is 0, a peak point currently carrying a signal waveform is definitely a point 0 of another signal waveform, as shown by a dotted line in the figure.

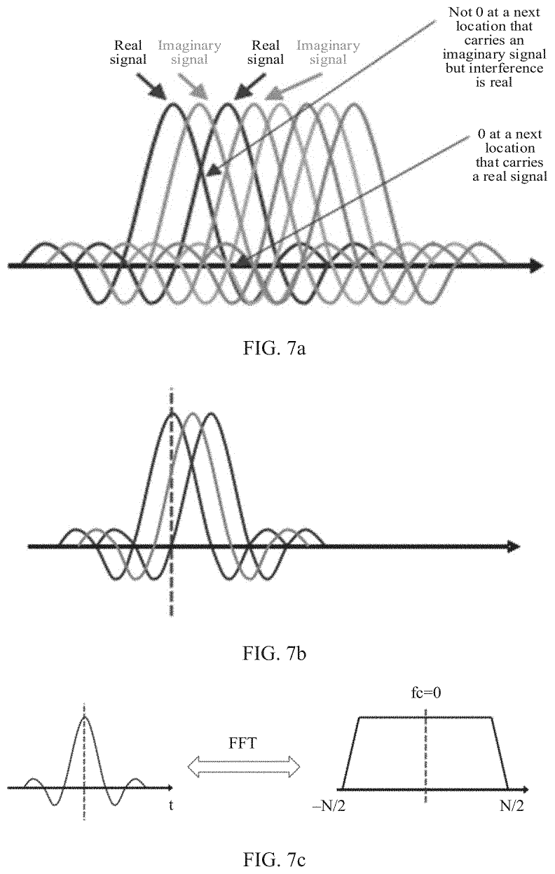

However, when a modulation scheme is SC-OQAM, as shown in FIG. 7a, a relationship between complex signals carried in the modulation scheme is a partial orthogonality relationship between a real part and an imaginary part. In this case, partial interference exists. Herein, a concept of the partial orthogonality relationship is that an SC-OQAM waveform carries a signal in which a real part and an imaginary part are separated, and there is a non-orthogonality relationship between a waveform of the signal and a waveform of a next signal. In other words, the waveform is not 0 at a sampling point of a next waveform that carries a signal. However, because signals carried by the next waveform that carries the signal are orthogonal, interference is orthogonal relative to the signals. Therefore, there is an orthogonality relationship between the current waveform and next two waveforms that carry signals.

When the SC-OQAM waveform is to be implemented, an SC-OQAM signal that passes through a filter is shown in FIG. 7b. A difference from conventional SC-QAM lies in that in the OQAM, a signal carried in a waveform is a pure real signal or a pure imaginary signal. Therefore, as shown in FIG. 7b, although a black waveform interferes with a gray waveform, because the black waveform carries a pure real signal, and the gray waveform carries a pure imaginary signal, in the SC-OQAM, real parts are orthogonal, or imaginary parts are orthogonal. Certainly, only when a waveform carrying a signal is also pure real or pure imaginary, a characteristic of being pure real or pure imaginary can be ensured by multiplying the waveform by a real part signal or a pure imaginary part signal. Therefore, a filter in the SC-OQAM needs to satisfy the following characteristics: there is an odd quantity of non-zero elements, the filter is pure real or pure imaginary, and the filter has symmetry. A frequency domain response of the filter in the SC-OQAM after Fourier transform is performed is shown in FIG. 7c. It can be learned that the frequency domain response of the filter is symmetric along a center point, and a quantity of frequency domain responses that are not 0 is N+1.

Due to the partial orthogonality relationship, a receive end removes an imaginary part when receiving the real signal, and removes a real part when receiving the imaginary part signal, so that information can be correctly replied. An advantage that a real part and an imaginary part are orthogonal is that a peak of a real part signal and a non-peak of an imaginary signal superimpose, and a method of staggering a peak can effectively reduce a PAPR.

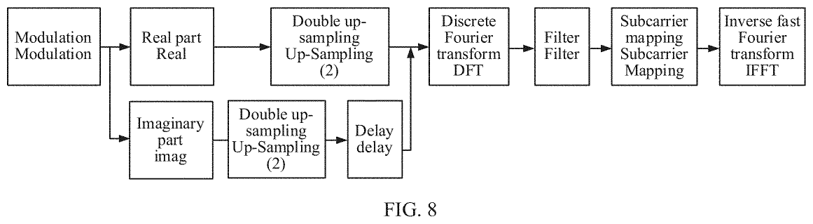

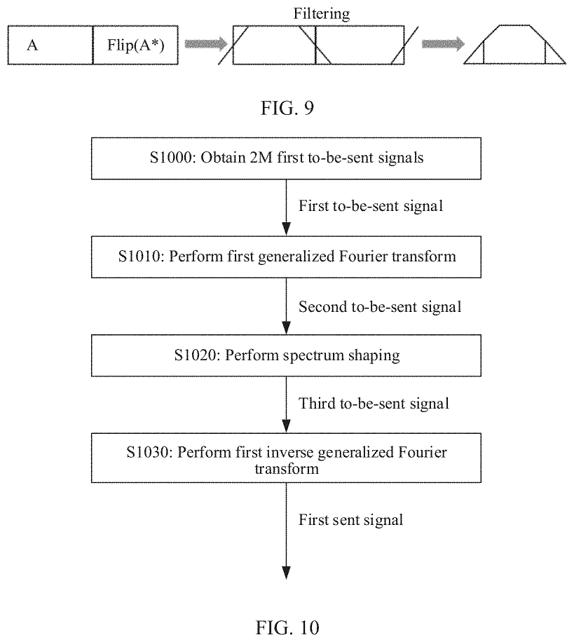

FIG. 8 is a schematic diagram of a frequency domain implementation procedure at a transmit end in SC-OQAM. There are two modifications in the frequency domain implementation procedure. (1) A real part and an imaginary part in QAM constellation points used in a DFT-S-OFDM system are separated (alternatively, it may be directly defined that a pulse amplitude modulation (PAM) signal rather than a QAM signal is input). After the modification is made, double up-sampling is performed. In other words, the real part signal becomes [X, 0, X, 0, X, 0, . . . ], and the imaginary part signal becomes [jY, 0, jY, 0, jY, 0, . . . ]. Then, a delay is added to the imaginary part signal, and the imaginary part signal becomes [0, jY, 0, jY, 0, jY, . . . ] and then, becomes [X, jY, X, jY, X, jY, . . . ] after the real part signal and the imaginary part signal are combined, and a total length becomes twice that of an original complex-modulated signal. Then, 2N-point DFT transform is performed on a symbol obtained through the phase rotation/after a real part and an imaginary part are separated. (2) Frequency domain shaping is performed on a signal obtained through the DFT transform, and a specific manner is shown in FIG. 9. Because QAM constellation modulation with separated real and imaginary parts is performed, and a length of a signal is twice that in conventional QAM constellation modulation, a length of a signal on which DFT needs to be performed is also twice that of a signal on which DFT needs to be performed in the conventional QAM constellation modulation. A signal obtained through the DFT has a characteristic, that is, a spectrum has a conjugate symmetry characteristic: s[n]=s*[N−n], that is, A and Filp (A*) shown in FIG. 9. Therefore, data obtained through the DFT is redundant. Therefore, truncated frequency domain filtering may be performed on a redundant signal. Being truncated means that a bandwidth of a filter is less than a bandwidth obtained through the DFT. For example, the bandwidth obtained through the DFT is 100 resource blocks (RB), and a filtering length of a frequency domain filter may be designed to be 60 RBs. The filtering process is that the frequency domain filter is directly multiplied by the signal obtained through the DFT. Because the signal is redundant, the truncated filtering does not cause performance loss. Finally, after IFFT transform is performed, a cyclic prefix (CP) is added and sent.

The following specifically describes a signal transmission method provided in an embodiment of this application:

Embodiment 1 of this application provides a signal transmission method. A main procedure and steps of the signal transmission method at a transmit end are shown in FIG. 10.

S1000: The transmit end obtains 2M first to-be-sent signals.

In a possible implementation, in the 2M first to-be-sent signals, a first to-be-sent signal with an odd sequence number includes only a real part signal, and a first to-be-sent signal with an even sequence number includes only an imaginary part signal. Alternatively, in the 2M first to-be-sent signals, a first to-be-sent signal with an even sequence number includes only a real part signal, and a first to-be-sent signal with an odd sequence number includes only an imaginary part signal. Alternatively, all the 2M first to-be-sent signals include only real part signals. Alternatively, all the 2M first to-be-sent signals include only imaginary part signals.

In a possible implementation, before the transmit end obtains 2M first to-be-sent signals, the method further includes the following steps: performing separation of a real part and an imaginary part on M original signals, then performing double sampling on a real part signal and an imaginary part signal that are obtained through the separation, and performing an operation of delaying one signal on the imaginary part signal. Optionally, an operation of delaying one signal may alternatively be performed on the real part signal. Therefore, 2M time domain signals with separated real and imaginary parts, that is, the 2M first to-be-sent signals, are generated. Optionally, the real part signal may be before the imaginary part signal, or the imaginary part signal may be before the real part signal.

S1010: The transmit end performs first generalized Fourier transform based on the 2M first to-be-sent signals, to obtain N second to-be-sent signals.

In a possible implementation, the first generalized Fourier transform includes the following steps: The transmit end performs first phase shift based on the first to-be-sent signal, to obtain a fourth to-be-sent signal. Then, the transmit end performs discrete Fourier transform (DFT) or fast Fourier transform (FFT) based on the fourth to-be-sent signal, to obtain the second to-be-sent signal. M and N are positive integers, and 2M is greater than or equal to N.

In a possible implementation, a value of the first phase shift satisfies the following formula:

$$e \frac{- j 2 π m α}{2 M} , \qquad ( Formula 1 )$$

where
α is 0.5 or −0.5, m∈[m₀, m₀+2M−1], m and m₀ are integers, m is a sequence number of the first to-be-sent signal, m₀ is a start sequence number of the first to-be-sent signal, M is a positive integer, and j=\sqrt{−1}. In a possible implementation, a may be (B+0.5) or (B−0.5), where B is an integer. B is subtracted from a constraint sequence number of a spectrum shaping coefficient A*P(k), so that for example, that N is an even number, M is an even number,

$${k}_{0} = - \frac{N - M}{2} + lM ,$$

and P(k) is conjugate symmetric about

$$k = - \frac{1 - M}{2} + lM$$

becomes that N is an even number, M is an even number,

$${k}_{0} = - \frac{N - M}{2} + lM - B ,$$

and P(k) is conjugate symmetric about

$$k = - \frac{1 - M}{2} + lM - B .$$

In a possible implementation, a value of m₀ is any one of 0, −M, or −M+1.

In a possible implementation, a numerator and a denominator of Formula 1 are both divided by 2, and Formula 1 may be represented as

$${e}^{\frac{- j π mα}{M}} .$$

It should be understood that the formula in this embodiment of this application may be properly modified provided that the formula meets a meaning expressed by the formula. Any modification of the formula falls within the protection scope of the embodiments of this application.

In a possible implementation, the second to-be-sent signal satisfies the following formula:

$${\sum }_{m = {m}_{0}}^{m = {m}_{0} + 2 M} x ( m ) {e}^{\frac{- j 2 π m ( k + α )}{2 M}} , \qquad ( Formula 2 )$$

where
α is 0.5 or −0.5, m∈[m₀, m₀+2M−1], m and m₀ are integers, x(m) is the first to-be-sent signal, m is a sequence number of the first to-be-sent signal, m₀ is a start sequence number of the first to-be-sent signal, M is a positive integer, k is a sequence number of a subcarrier that performs frequency sampling on x(m), and j=\sqrt{−1}.

S1020: The transmit end performs spectrum shaping based on the N second to-be-sent signals, to obtain N third to-be-sent signals.

In a possible implementation, the spectrum shaping includes the following steps: The transmit end performs frequency domain shaping on the N second to-be-sent signals by using a filter whose filter length is N; multiplies, by a spectrum shaping coefficient A*P(k), the N second to-be-sent signals obtained through the frequency domain shaping, where k ∈ [k₀, k₀+N−1], k is a sequence number of a subcarrier, k₀ is a sequence number of a start location of the subcarrier, and A is a complex constant, may be usually 1 or another value, such as e^{-jθ}; and then, obtains the N third to-be-sent signals.

In a possible implementation, when all the 2M first to-be-sent signals include only real part signals, or when all the 2M first to-be-sent signals include only imaginary part signals, symmetry of P(k) is related to a value of α, and a relationship is shown as follows:

When α=0.5,
N is an even number, M is an even number,

$${k}_{0} = - \frac{N - M}{2} + lM ,$$

and P(k) is conjugate symmetric about

$$k = - \frac{1 - M}{2} + lM ;$$

in other words, when

$$\frac{{z}_{1} + {z}_{2}}{2} = - \frac{1 - M}{2} + lM ,$$

P(z₁)=conj(P(z₂)); or
N is an odd number, M is an odd number,

$${k}_{0} = - \frac{N - M}{2} + lM ,$$

and P(k) is conjugate symmetric about

$$k = - \frac{1 - M}{2} + lM ;$$

in other words, when

$$\frac{{z}_{1} + {z}_{2}}{2} = - \frac{1 - M}{2} + l M ,$$

P(z₁)=conj(P(z₂)).

When α=−0.5,
N is an even number, M is an even number,

$${k}_{0} = - \frac{N - M}{2} - 1 + l M ,$$

and P(k) is conjugate symmetric about

$$k = \frac{1 + M}{2} + l M ;$$

in other words, when

$$\frac{{z}_{1} + {z}_{2}}{2} = \frac{1 + M}{2} + l M ,$$

P(z₁)=conj(P(z₂)); or
N is an odd number, M is an odd number,

$${k}_{0} = - \frac{N - M}{2} - 1 + l M ,$$

and P(k) is conjugate symmetric about

$$k = \frac{1 + M}{2} + l M ;$$

in other words, when

$$\frac{{z}_{1} + {z}_{2}}{2} = \frac{1 + M}{2} + l M ,$$

P(z₁)=conj(P(z₂)).

conj(a+jb)=a−jb, and l is an integer and may generally be 0, 1, −1, or the like.

In other words, when all the 2M first to-be-sent signals include only real part signals, or when all the 2M first to-be-sent signals include only imaginary part signals, parity of N and parity of M are the same, that is, N and M are both odd numbers or even numbers.

In a possible implementation, when in the 2M first to-be-sent signals, a first to-be-sent signal with an odd sequence number includes only a real part signal, and a first to-be-sent signal with an even sequence number includes only an imaginary part signal, or when in the 2M first to-be-sent signals, a first to-be-sent signal with an even sequence number includes only a real part signal, and a first to-be-sent signal with an odd sequence number includes only an imaginary part signal, symmetry of P(k) is related to a value of α, and a relationship is shown as follows:

When α=0.5, N is an even number,

$${k}_{0} = - \frac{N}{2} + l M ,$$

and P(k) is conjugate symmetric about k=−½+lM; in other words, when

$$\frac{{z}_{1} + {z}_{2}}{2} = - \frac{1}{2} + l M ,$$

P(z₁)=conj(P(z₂)).

When α=−0.5, N is an even number,

$${k}_{0} = - \frac{N}{2} - 1 + l M ,$$

and P(k) is conjugate symmetric about k=½+lM; in other words, when

$$\frac{{z}_{1} + {z}_{2}}{2} = \frac{1}{2} + l M ,$$

P(z₁)=conj(P(z₂)).

l is an integer and may generally be 0, 1, −1, or the like.

In a possible implementation, if the filter length of the filter used for spectrum shaping is N and is even symmetric, a formula for performing spectrum shaping on a k^{th} subcarrier may be represented as:

$$\{ {\sum }_{m = {m}_{0}}^{m = {m}_{0} + 2 M} x ( m ) {e}^{\frac{- j 2 π m ( k + α )}{2 M}} \} P ( k ) ,$$

k ∈ [k₀, k₀+N−1] (Formula 3), where
α is 0.5 or −0.5, m∈[m₀, m₀+2M−1], m and m₀ are integers, x(m) is the first to-be-sent signal, m is a sequence number of the first to-be-sent signal, m₀ is a start sequence number of the first to-be-sent signal, M is a positive integer, k is a sequence number of a subcarrier that performs frequency sampling on x(m), k₀ is a start sequence of the subcarrier that performs frequency sampling on x(m), k and k₀ are integers, and j=\sqrt{−1}.

In a possible implementation, after the spectrum shaping, the transmit end performs subcarrier mapping based on the N third to-be-sent signals, and maps, to N subcarriers, the N third to-be-sent signals obtained through the filtering. Herein, the N third to-be-sent signals obtained through the filtering are mapped to a subcarrier location that is an integer multiple.

S1030: The transmit end performs first inverse generalized Fourier transform based on the N third to-be-sent signals, to obtain and send a first sent signal.

In a possible implementation, the first inverse generalized Fourier transform includes the following steps: The transmit end performs inverse discrete Fourier transform (IDFT) or inverse fast Fourier transform (IFFT) based on the third to-be-sent signal, to obtain a fifth to-be-sent signal. Then, the transmit end performs second phase shift based on the fifth to-be-sent signal, to obtain the first sent signal.

In a possible implementation, a value of the second phase shift is 1, that is, the step of the second phase shift is omitted.

In a possible implementation, after the transmit end performs the IDFT or the IFFT based on the third to-be-sent signal, and before the transmit end performs the second phase shift, the method further includes a step of adding a cyclic prefix CP to the to-be-sent signal.

In another possible implementation, after the transmit end performs the second phase shift based on the fifth to-be-sent signal, the method further includes a step of adding a CP to the to-be-sent signal.

In a possible implementation, the first sent signal y(t) obtained at last satisfies the following formula:

$$y ( t ) = {\sum }_{k = {k}_{0}}^{k = {k}_{0} + N - 1} \text{} \{ {\sum }_{m = {m}_{0}}^{m = {m}_{0} + 2 M} x ( m ) {e}^{\frac{- j 2 π m ( k + α )}{2 M}} \} P ( k ) {e}^{j 2 π ( k + {k}_{1} ) Δ f ( t - {t}_{0} )} , \qquad ( Formula 4 )$$

where
α is 0.5 or −0.5, m∈[m₀, m₀+2M−1], m and m₀ are integers, x(m) is the first to-be-sent signal, m is a sequence number of the first to-be-sent signal, m₀ is a start sequence number of the first to-be-sent signal, M is a positive integer, k is a sequence number of a subcarrier that performs frequency sampling on x(m), k₀ is a start sequence of the subcarrier that performs frequency sampling on x(m), k and k₀ are integers, and j=\sqrt{−1}, Δf is a subcarrier width (in a unit of Hertz Hz), and t₀ (in a unit of second s) determines an actual time location of the first sent signal y(t).

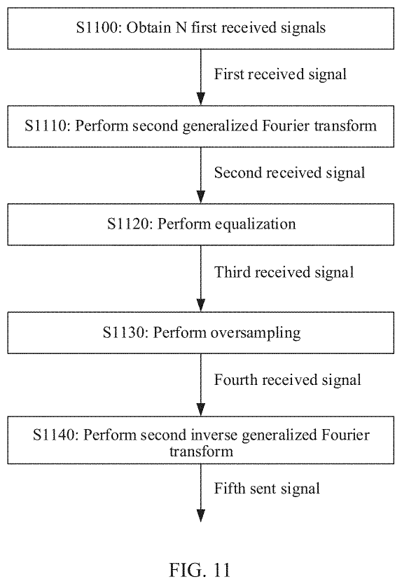

A main procedure and steps at a receive end corresponding to the transmit end in Embodiment 1 are shown in FIG. 11.

S1100: The receive end obtains N first received signals.

S1110: The receive end performs second generalized Fourier transform based on the N first received signals, to obtain N second received signals.

In a possible implementation, the second generalized Fourier transform includes the following steps: The receive end performs third phase shift based on the first received signal, to obtain a sixth received signal. Then, the receive end performs discrete Fourier transform DFT or fast Fourier transform FFT based on the sixth received signal, to obtain the second received signal.

In a possible implementation, before the receive end performs third phase shift based on the first received signal, the method further includes a step of removing a CP based on the first received signal.

In another possible implementation, after the receive end performs third phase shift based on the first received signal, and before the receive end performs DFT or FFT based on the sixth received signal, the method further includes a step of removing a CP based on the received signal.

In a possible implementation, a value of the third phase shift is 1, that is, the step of the third phase shift is omitted.

In a possible implementation, after the receive end performs second generalized Fourier transform based on the N first received signals, the method further includes a step of performing demapping based on the received signals. Frequency domain locations of signals obtained through the demapping are symmetrically placed along a center frequency. N frequency domain signals are obtained through the demapping.

S1120: The receive end performs equalization based on the N second received signals, to obtain N third received signals.

In a possible implementation, a manner in which the receive end performs equalization on the second received signal includes at least one of the following: a least squares method or a minimum mean-square error criterion.

S1130: The receive end performs oversampling based on the N third received signals, to obtain 2M fourth received signals.

In a possible implementation, the receive end performs oversampling on the N third received signals obtained through the matched filtering, that is, inserts 0 signals to beginnings and/or ends of the N third received signals, to obtain the 2M fourth received signals.

S1140: The receive end performs second inverse generalized Fourier transform based on the 2M fourth received signals, to obtain a fifth received signal.

In a possible implementation, the second inverse generalized Fourier transform includes the following steps: The receive end performs inverse discrete Fourier transform IDFT or inverse fast Fourier transform IFFT based on the fourth received signal, to obtain a seventh received signal. Then, the receive end performs fourth phase shift based on the seventh received signal, to obtain the fifth received signal.

In a possible implementation, a value of the fourth phase shift satisfies the following formula:

$${e}^{\frac{j 2 π m α}{2 M}} , \qquad ( Formula 5 )$$

where
α is 0.5 or −0.5, m∈[m₀, m₀+2M−1], m and m₀ are integers, M is a positive integer, and j=\sqrt{−1}.

In a possible implementation, a numerator and a denominator of Formula 4 are both divided by 2, and Formula 4 may be represented as

$${e}^{\frac{j π m α}{M}} .$$

It should be understood that the formula in this embodiment of this application may be properly modified provided that the formula meets a meaning expressed by the formula. Any modification of the formula falls within the protection scope of the embodiments of this application.

In a possible implementation, the receive end extracts a signal based on the 2M fifth received signals in a data placement manner at the transmit end. For example, a real part is extracted from a signal at an odd-numbered index location, and an imaginary part is extracted from a signal at an even-numbered index location. Alternatively, a real part is extracted from a signal at an even-numbered index location, and an imaginary part is extracted from a signal at an odd-numbered index location.

In the foregoing embodiment, a sampling operation with an offset of ½ is performed on a conventional odd-order filter in SC-OQAM, to obtain an even-order filter. It can be learned from the foregoing embodiment that, after the offset sampling is performed, the conventional odd-order filter becomes the even-order filter and is symmetric. Based on a Fourier transform characteristic, a time domain response of the filter is also even and symmetric. However, because the offset of ½ is performed on the filter, the same operation needs to be performed on a signal, so that the signal also has an offset of ½ in frequency domain. In this way, spectrum sampling of the signal matches spectrum sampling of the filter. An implementation in which a frequency domain signal has an offset of ½ is multiplying the frequency domain signal by a linearly changing phase in time domain, for example, the operation of performing the first phase shift on the first to-be-sent signal in the first generalized Fourier transform in S1010. Although the offset of ½ is performed on the filter, actual signal mapping is not affected, and a signal is mapped back to a subcarrier location that is an integer.

It can be learned that, in the method described in the foregoing embodiment, on a premise that no ISI is introduced, an even-order filter is obtained by performing offset sampling on an odd-order filter, so that the even-order filter is used to be compatible with scheduling of an even multiple of frequency domain resources in a currently commonly used implementation method. This facilitates frequency domain resource scheduling, and resolves a conventional-technology problem of being incompatible with a resource scheduling manner in an existing protocol when a response of a filter has an odd quantity of points.

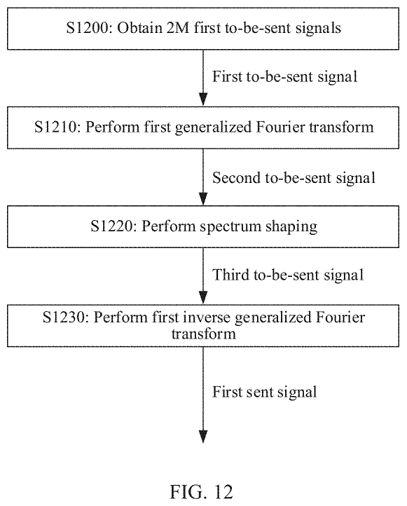

Embodiment 2 of this application further provides a signal transmission method. A main procedure and steps of the signal transmission method at a transmit end are shown in FIG. 12.

S1200: The transmit end obtains 2M first to-be-sent signals.

In a possible implementation, in the 2M first to-be-sent signals, a first to-be-sent signal with an odd sequence number includes only a real part signal, and a first to-be-sent signal with an even sequence number includes only an imaginary part signal. Alternatively, in the 2M first to-be-sent signals, a first to-be-sent signal with an even sequence number includes only a real part signal, and a first to-be-sent signal with an odd sequence number includes only an imaginary part signal. Alternatively, all the 2M first to-be-sent signals include only real part signals. Alternatively, all the 2M first to-be-sent signals include only imaginary part signals.

In a possible implementation, before the transmit end obtains 2M first to-be-sent signals, the method further includes the following steps: performing separation of a real part and an imaginary part on M original signals, then performing double sampling on a real part signal and an imaginary part signal that are obtained through the separation, and performing an operation of delaying one signal on the imaginary part signal. Optionally, an operation of delaying one signal may alternatively be performed on the real part signal. Therefore, 2M time domain signals with separated real and imaginary parts, that is, the 2M first to-be-sent signals, are generated. Optionally, the real part signal may be before the imaginary part signal, or the imaginary part signal may be before the real part signal.

S1210: The transmit end performs first generalized Fourier transform based on the 2M first to-be-sent signals, to obtain N second to-be-sent signals.

In a possible implementation, the first generalized Fourier transform includes the following steps: The transmit end performs first phase shift based on the first to-be-sent signal, to obtain a fourth to-be-sent signal. Then, the transmit end performs discrete Fourier transform (DFT) or fast Fourier transform (FFT) based on the fourth to-be-sent signal, to obtain the second to-be-sent signal. M and N are positive integers, and 2M is greater than or equal to N.

In a possible implementation, a value of the first phase shift satisfies the following formula:

$${e}^{\frac{- j 2 π m α}{2 M}} , \qquad ( Formula 1 )$$

where
α is 0.5 or −0.5, m∈[m₀, m₀+2M−1], m and m₀ are integers, m is a sequence number of the first to-be-sent signal, m₀ is a start sequence number of the first to-be-sent signal, M is a positive interger, and j=\sqrt{−1}.

In a possible implementation, a value of m₀ is any one of 0, −M, or −M+1.

In a possible implementation, a numerator and a denominator of Formula 1 are both divided by 2, and Formula 1 may be represented as

$${e}^{\frac{- j π m α}{M}} .$$

It should be understood that the formula in this embodiment of this application may be properly modified provided that the formula meets a meaning expressed by the formula. Any modification of the formula falls within the protection scope of the embodiments of this application.

In a possible implementation, the second to-be-sent signal meets the following formula:

$${\sum }_{m = {m}_{0}}^{m = {m}_{0} + 2 M} x ( m ) {e}^{\frac{- j 2 π m ( k + α )}{2 M}} , \qquad ( Formula 2 )$$

where
α is 0.5 or −0.5, m∈[m₀, m₀+2M−1], m and m₀ are integers, x(m) is the first to-be-sent signal, m is a sequence number of the first to-be-sent signal, m₀ is a start sequence number of the first to-be-sent signal, M is a positive integer, k is a sequence number of a subcarrier that performs frequency sampling on x(m), and j=\sqrt{−1}.

S1220: The transmit end performs spectrum shaping based on the N second to-be-sent signals, to obtain N third to-be-sent signals.

In a possible implementation, the spectrum shaping includes the following steps: The transmit end performs frequency domain shaping on the N second to-be-sent signals by using a filter whose filter length is N; multiplies, by a spectrum shaping coefficient A*P(k), the N second to-be-sent signals obtained through the frequency domain shaping, where k ∈ [k₀, k₀+N−1], k is a sequence number of a subcarrier, k₀ is a sequence number of a start location of the subcarrier, and A is a complex constant, may be usually 1 or another value, such as e^{-jθ}; and then, obtains the N third to-be-sent signals.

In a possible implementation, when all the 2M first to-be-sent signals include only real part signals, or when all the 2M first to-be-sent signals include only imaginary part signals, symmetry of P(k) is related to a value of α, and a relationship is shown as follows:

When α=0.5,
N is an even number, M is an even number,

$${k}_{0} = - \frac{N - M}{2} + lM ,$$

and P(k) is conjugate symmetric about

$$k = - \frac{1 - M}{2} + lM ;$$

in other words, when

$$\frac{{z}_{1} + {z}_{2}}{2} = - \frac{1 - M}{2} + lM ,$$

P(z₁)=conj(P(z₂)); or
N is an odd number, M is an odd number,

$${k}_{0} = - \frac{N - M}{2} + lM ,$$

and P(k) is conjugate symmetric about

$$k = - \frac{1 - M}{2} + lM ;$$

in other words, when

$$\frac{{z}_{1} + {z}_{2}}{2} = - \frac{1 - M}{2} + lM ,$$

P(z₁)=conj(P(z₂)).

When α=−0.5,
N is an even number, M is an even number,

$${k}_{0} = - \frac{N - M}{2} - 1 + lM ,$$

and P(k) is conjugate symmetric about

$$k = \frac{1 + M}{2} + lM ;$$

in otner words, when

$$\frac{{z}_{1} + {z}_{2}}{2} = \frac{1 + M}{2} + lM ,$$

P(z₁)=conj(P(z₂)); or
N is an odd number, M is an odd number,

$${k}_{0} = - \frac{N - M}{2} - 1 + lM ,$$

and P(k) is conjugate symmetric about

$$k = \frac{1 + M}{2} + lM ;$$

in other words, when

$$\frac{{z}_{1} + {z}_{2}}{2} = \frac{1 + M}{2} + lM ,$$

P(z₁)=conj(P(z₂)).

l is an integer and may generally be 0, 1, −1, or the like.

In other words, when all the 2M first to-be-sent signals include only real part signals, or when all the 2M first to-be-sent signals include only imaginary part signals, parity of N and parity of M are the same, that is, N and M are both odd numbers or even numbers.

In a possible implementation, when in the 2M first to-be-sent signals, a first to-be-sent signal with an odd sequence number includes only a real part signal, and a first to-be-sent signal with an even sequence number includes only an imaginary part signal, or when in the 2M first to-be-sent signals, a first to-be-sent signal with an even sequence number includes only a real part signal, and a first to-be-sent signal with an odd sequence number includes only an imaginary part signal, symmetry of P(k) is related to a value of α, and a relationship is shown as follows:

When α=0.5, N is an even number,

$${k}_{0} = - \frac{N}{2} + l M ,$$

and P(k) is conjugate symmetric about k=−½+lm; in other words, when

$$\frac{{z}_{1} + {z}_{2}}{2} = - \frac{1}{2} + l M ,$$

P(z₁)=conj(P(z₂)).

When α=−0.5, N is an even number,

$${k}_{0} = - \frac{N}{2} - 1 + l M ,$$

and P(k) is conjugate symmetric about k=½+lM; in other words, when

$$\frac{{z}_{1} + {z}_{2}}{2} = \frac{1}{2} + l M ,$$

P(z₁)=conj(P(z₂)).

l is an integer and may generally be 0, 1, −1, or the like.

In a possible implementation, if the filter length of the filter used for spectrum shaping is N and is even symmetric, a formula for performing spectrum shaping on a k^{th} subcarrier may be represented as:

$$\{ {\sum }_{m = {m}_{0}}^{m = {m}_{0} + 2 M} x ( m ) {e}^{\frac{- j 2 π m ( k + α )}{2 M}} \} P ( k ) , k ∈ [ {k}_{0} , {k}_{0} + N - 1 ] , \qquad ( Formula 3 )$$

where
α is 0.5 or −0.5, m∈[m₀, m₀+2M−1], m and m₀ are integers, x(m) is the first to-be-sent signal, m is a sequence number of the first to-be-sent signal, m₀ is a start sequence number of the first to-be-sent signal, M is a positive integer, k is a sequence number of a subcarrier that performs frequency sampling on x(m), k₀ is a start sequence of the sub carrier that performs frequency sampling on x(m), k and k₀ are integers, and j=\sqrt{−1}.

In a possible implementation, after the spectrum shaping, the transmit end performs subcarrier mapping based on the N third to-be-sent signals, and maps, to N subcarriers, the N third to-be-sent signals obtained through the filtering.

S1230: The transmit end performs first inverse generalized Fourier transform based on the N third to-be-sent signals, to obtain and send a first sent signal.

In a possible implementation, the first inverse generalized Fourier transform includes the following steps: The transmit end performs inverse discrete Fourier transform (IDFT) or inverse fast Fourier transform (IFFT) based on the third to-be-sent signal, to obtain a fifth to-be-sent signal. Then, the transmit end performs second phase shift based on the fifth to-be-sent signal, to obtain the first sent signal.

In a possible implementation, a value of the second phase shift satisfies the following formula:

$${e}^{\frac{j 2 π m α}{2 M}} , \qquad ( Formula 5 )$$

where
α is 0.5 or −0.5, m∈[m₀, m₀+2M−1], m and m₀ are integers, M is a positive integer, and j=\sqrt{−1}. Different from the foregoing embodiment, phase rotation is further performed on the time domain signal herein. In other words, that the value of the second phase shift is not 0 is equivalent to that frequency domain mapping is mapping a frequency domain signal to a frequency domain location offset by a ½ subcarrier spacing relative to a subcarrier spacing that is an integer multiple.

In a possible implementation, a numerator and a denominator of Formula 5 are both divided by 2, and Formula 5 may be represented as

$${e}^{\frac{j π m α}{M}} .$$

It should be understood that the formula in this embodiment of this application may be properly modified provided that the formula meets a meaning expressed by the formula. Any modification of the formula falls within the protection scope of the embodiments of this application.

In a possible implementation, after the transmit end performs the IDFT or the IFFT based on the third to-be-sent signal, and before the transmit end performs the second phase shift, the method further includes a step of adding a cyclic prefix CP to the to-be-sent signal.

In another possible implementation, after the transmit end performs the second phase shift based on the fifth to-be-sent signal, the method further includes a step of adding a CP to the to-be-sent signal.

In a possible implementation, the first sent signal y(t) obtained at last satisfies the following formula:

$$y ( t ) = {\sum }_{k = {k}_{0}}^{k = {k}_{0} + N - 1} \{ {\sum }_{m = {m}_{0}}^{m = {m}_{0} + 2 M} x ( m ) e \frac{- j 2 π m ( k + α )}{2 M} \} P ( k ) {e}^{j 2 π ( k + α + {k}_{1} ) Δf ( t - {t}_{0} )} , \qquad ( Formula 6 )$$

where
α is 0.5 or −0.5, m∈[m₀, m₀+2M−1], m and m₀ are integers, x(m) is the first to-be-sent signal, m is a sequence number of the first to-be-sent signal, m₀ is a start sequence number of the first to-be-sent signal, M is a positive integer, k is a sequence number of a subcarrier that performs frequency sampling on x(m), k₀ is a start sequence of the sub carrier that performs frequency sampling on x(m), k and k₀ are integers, j=\sqrt{−1}, Δf is a subcarrier width (in a unit of Hertz Hz), and t₀ (in a unit of second s) determines an actual time location of the first sent signal y(t).

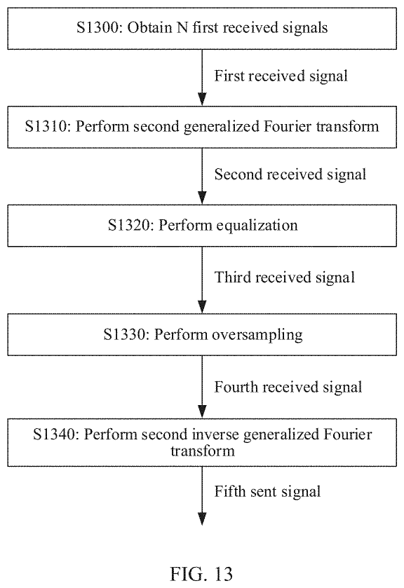

A main procedure and steps at a receive end corresponding to the transmit end in Embodiment 2 are shown in FIG. 13.

S1300: A receive end obtains N first received signals.

S1310: The receive end performs second generalized Fourier transform based on the N first received signals, to obtain N second received signals.

In a possible implementation, the second generalized Fourier transform includes the following steps: The receive end performs third phase shift based on the first received signal, to obtain a sixth received signal. Then, the receive end performs discrete Fourier transform DFT or fast Fourier transform FFT based on the sixth received signal, to obtain the second received signal.

In a possible implementation, before the receive end performs third phase shift based on the first received signal, the method further includes a step of removing a CP based on the first received signal.

In another possible implementation, after the receive end performs third phase shift based on the first received signal, and before the receive end performs DFT or FFT based on the sixth received signal, the method further includes a step of removing a CP based on the received signal.

In a possible implementation, a value of the third phase shift satisfies the following formula:

$${e}^{\frac{- j2 π m α}{2 M}} , \qquad ( Formula 1 )$$

where
α is 0.5 or −0.5, m∈[m₀, m₀+2M−1], m and m₀ are integers, M is a positive integer, and j=\sqrt{−1}.

In a possible implementation, a numerator and a denominator of Formula 1 are both divided by 2, and Formula 1 may be represented as

$${e}^{\frac{- j π m α}{M}} .$$

It should be understood that the formula in this embodiment of this application may be properly modified provided that the formula meets a meaning expressed by the formula. Any modification of the formula falls within the protection scope of the embodiments of this application.

In a possible implementation, after the receive end performs second generalized Fourier transform based on the N first received signals, the method further includes a step of performing demapping based on the received signals. Frequency domain locations of signals obtained through the demapping are symmetrically placed along a center frequency. N frequency domain signals in subcarrier spacings that are integer multiples are obtained through the demapping.

In another possible implementation, after the receive end performs second generalized Fourier transform based on the N first received signals, the method further includes a step of performing demapping based on the received signals. Frequency domain locations of signals obtained through the demapping are symmetrically placed along a center frequency. N+1 frequency domain signals in subcarrier spacings that are integer multiples are obtained through the demapping.

S1320: The receive end performs equalization based on the second received signal, to obtain a third received signal.

In a possible implementation, a manner in which the receive end performs equalization on the second received signal includes at least one of the following: a least squares method or a minimum mean-square error criterion.

S1330: The receive end performs oversampling based on the third received signal, to obtain 2M fourth received signals.

In a possible implementation, the receive end performs oversampling on the N third received signals obtained through the matched filtering, that is, inserts 0 signals to beginnings and/or ends of the N third received signals, to obtain the 2M fourth received signals.

In another possible implementation, the receive end performs oversampling on the N+1 third received signals obtained through the matched filtering, that is, inserts 0 signals to beginnings and/or ends of the N third received signals with one side missing a 0 signal compared with an even symmetry structure, to obtain the 2M fourth received signals.

S1340: The receive end performs second inverse generalized Fourier transform based on the 2M fourth received signals, to obtain a fifth received signal.

In a possible implementation, the second inverse generalized Fourier transform includes the following steps: The receive end performs inverse discrete Fourier transform IDFT or inverse fast Fourier transform IFFT based on the fourth received signal, to obtain a seventh received signal. Then, the receive end performs fourth phase shift based on the seventh received signal, to obtain the fifth received signal.

In a possible implementation, a value of the fourth phase shift satisfies the following formula:

$${e}^{\frac{j 2 π m α}{2 M}} , \qquad ( Formula 5 )$$

where
α is 0.5 or −0.5, m∈[m₀, m₀+2M−1], m and m₀ are integers, M is a positive integer, and j=\sqrt{−1}.

In a possible implementation, a numerator and a denominator of Formula 4 are both divided by 2, and Formula 4 may be represented as

$${e}^{\frac{j π m α}{M}} .$$

It should be understood that the formula in this embodiment of this application may be properly modified provided that the formula meets a meaning expressed by the formula. Any modification of the formula falls within the protection scope of the embodiments of this application.

In a possible implementation, the receive end extracts a signal based on the 2M fifth received signals in a data placement manner at the transmit end. For example, a real part is extracted from a signal at an odd-numbered index location, and an imaginary part is extracted from a signal at an even-numbered index location. Alternatively, a real part is extracted from a signal at an even-numbered index location, and an imaginary part is extracted from a signal at an odd-numbered index location.

Compared with Embodiment 1, a difference in this embodiment lies in that subcarrier mapping is mapping to a resource element (RE) offset by a ½ subcarrier, instead of mapping to a subcarrier location that is an integer multiple and that is not offset in Embodiment 1.

Therefore, there are two processing manners at the receive end in Embodiment 2. Although the received signal is placed at a ½ subcarrier location, signal processing may be performed either at a subcarrier location offset by ½ or at a subcarrier location that is an integer multiple. This depends on a placement location of a demodulation reference signal (DMRS). Solution (1): When the DMRS is placed at the subcarrier location that is an integer multiple, signal processing may be performed at a subcarrier that is an integer multiple. When the solution is used, a quantity of subcarriers of the DMRS needs to be configured as N+1. In this case, an odd-order filter is used to perform matched filtering. Because mutual interference between a real part and an imaginary part does not exist in this case, no interference exists in the matched filtering. Therefore, the receive end does not need to perform phase compensation in the previous embodiment. Solution (2): When the DMRS is placed at a subcarrier location offset by ½, signal processing may be performed at the subcarrier location offset by ½. When the solution is used, a quantity of subcarriers of the DMRS needs to be configured as N. In this case, an even-order filter is used to perform matched filtering. In this case, interference exists in the matched filtering. Therefore, the receive end also needs to perform phase compensation in the previous embodiment.

The two receiver processing manners in Embodiment 2 may be compatible with different systems. In LTE downlink transmission and 5G downlink transmission, a subcarrier mapping manner is mapping to a subcarrier location that is an integer multiple. Therefore, the solution (1) is more easily compatible with an existing subcarrier mapping solution for LTE downlink transmission and 5G downlink transmission. In LTE uplink transmission, a subcarrier mapping manner is mapping to a subcarrier location offset by ½. Therefore, the solution (2) is more easily compatible with an existing subcarrier mapping solution for LTE uplink transmission.

Similarly, in the method described in Embodiment 2, on a premise that no ISI is introduced, an even-order filter is obtained by performing offset sampling on an odd-order filter, so that the even-order filter is used to be compatible with scheduling of an even multiple of frequency domain resources in a currently commonly used implementation method. This facilitates frequency domain resource scheduling, and is more easily compatible with existing subcarrier mapping solutions for LTE and 5G. This resolves a conventional-technology problem of being incompatible with a resource scheduling manner in an existing protocol when a response of a filter has an odd quantity of points.

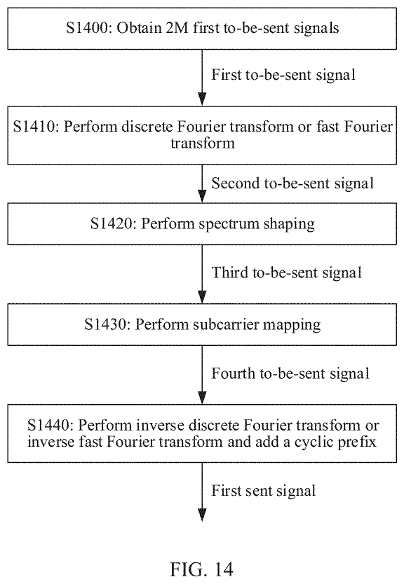

Embodiment 3 of this application further provides a signal transmission method. A main procedure and steps of the signal transmission method at a transmit end are shown in FIG. 14.

S1400: The transmit end obtains 2M first to-be-sent signals.

In a possible implementation, in the 2M first to-be-sent signals, a first to-be-sent signal with an odd sequence number includes only a real part signal, and a first to-be-sent signal with an even sequence number includes only an imaginary part signal. Alternatively, in the 2M first to-be-sent signals, a first to-be-sent signal with an even sequence number includes only a real part signal, and a first to-be-sent signal with an odd sequence number includes only an imaginary part signal. Alternatively, all the 2M first to-be-sent signals include only real part signals. Alternatively, all the 2M first to-be-sent signals include only imaginary part signals.

In a possible implementation, before the transmit end obtains 2M first to-be-sent signals, the method further includes the following steps: performing separation of a real part and an imaginary part on M original signals, then performing double sampling on a real part signal and an imaginary part signal that are obtained through the separation, and performing an operation of delaying one signal on the imaginary part signal. Optionally, an operation of delaying one signal may alternatively be performed on the real part signal. Therefore, 2M time domain signals with separated real and imaginary parts, that is, the 2M first to-be-sent signals, are generated. Optionally, the real part signal may be before the imaginary part signal, or the imaginary part signal may be before the real part signal.

S1410: The transmit end performs DFT or FFT based on the 2M first to-be-sent signals, to obtain 2M second to-be-sent signals.

In a possible implementation, the second to-be-sent signal satisfies the following formula:

$${\sum }_{m = {m}_{0}}^{m = {m}_{0} + 2 M} x ( m ) {e}^{\frac{- j 2 π m ( k )}{2 M}} , \qquad ( Formula 7 )$$

where
m∈[m₀, m₀+2M−1], m and m₀ are integers, x(m) is the first to-be-sent signal, m is a sequence number of the first to-be-sent signal, m₀ is a start sequence number of the first to-be-sent signal, M is a positive integer, k is a sequence number of a subcarrier that performs frequency sampling on x(m), k is an integer, and j=\sqrt{−1}.

In a possible implementation, a value of m₀ is any one of 0, −M, or −M+1.

S1420: The transmit end performs spectrum shaping based on the 2M second to-be-sent signals, to obtain N third to-be-sent signals.

In a possible implementation, frequency domain shaping is performed on the N second to-be-sent signals by using a symmetric filter whose filter length is N that is odd. The N second to-be-sent signals obtained through the frequency domain shaping are multiplied by a spectrum shaping coefficient A*P(k), where k ∈ [k₀, k₀+N−1], k is a sequence number of a subcarrier, k₀ is a sequence number of a start location of the subcarrier, and A is a complex constant, may be usually 1 or another value, such as e^{-jθ}. Then, the N third to-be-sent signals are obtained.

In a possible implementation, when in the 2M first to-be-sent signals, a first to-be-sent signal with an odd sequence number includes only a real part signal, and a first to-be-sent signal with an even sequence number includes only an imaginary part signal, or when in the 2M first to-be-sent signals, a first to-be-sent signal with an even sequence number includes only a real part signal, and a first to-be-sent signal with an odd sequence number includes only an imaginary part signal, N is an odd number,

$${k}_{0} = - \frac{N - 1}{2} + l M ,$$

P(k) and is conjugate symmetric about k=lM. In other words, when k=lM, P(z₁)=conj(P(z₂)), where l is an integer and is usually 0, 1, −1, or the like.

In a possible implementation, when all the 2M first to-be-sent signals include only real part signals, or when all the 2M first to-be-sent signals include only imaginary part signals, M and N have different parity,

$${k}_{0} = - \frac{N - ( M + 1 )}{2} + l M ,$$

and P(k) is conjugate symmetric about

$$k = \frac{M}{2} + lM .$$

In other words, when

$$\frac{{z}_{1} + {z}_{2}}{2} = \frac{M}{2} + lM ,$$

P(z₁)=conj(P(z₂)), where l is an integer and may be generally 0, 1, −1, or the like.

S1430: The transmit end performs subcarrier mapping based on the third to-be-sent signal, to obtain a fourth to-be-sent signal.

In a possible implementation, the transmit end maps the third to-be-sent signal to a subcarrier location that is an integer multiple.

S1440: The transmit end performs IDFT or IFFT based on the fourth to-be-sent signal, and adds a CP, to obtain and send a first to-be-sent signal.

In a possible implementation, the first sent signal y(t) obtained at last satisfies the following formula:

$$y ( t ) = {\sum }_{k = {k}_{0}}^{k = {k}_{0} + N - 1} \{ {\sum }_{m = {m}_{0}}^{m = {m}_{0} + 2 M} x ( m ) {e}^{\frac{- j 2 π mk}{2 M}} \} P ( k ) {e}^{j 2 π ( k + {k}_{1} ) Δ f ( t - {t}_{0} )} , \qquad ( Formula 8 )$$

where
m∈[m₀, m₀+2M−1], m and m₀ are integers, x(m) is the first to-be-sent signal, m is a sequence number of the first to-be-sent signal, m₀ is a start sequence number of the first to-be-sent signal, M is a positive integer, k is a sequence number of a subcarrier that performs frequency sampling on x(m), k₀ is a start sequence of the subcarrier that performs frequency sampling on x(m), k and k₀ are integers, j=\sqrt{−1}, Δf is a subcarrier width (in a unit of Hertz Hz), and t₀ (in a unit of second s) determines an actual time location of the first sent signal y(t).

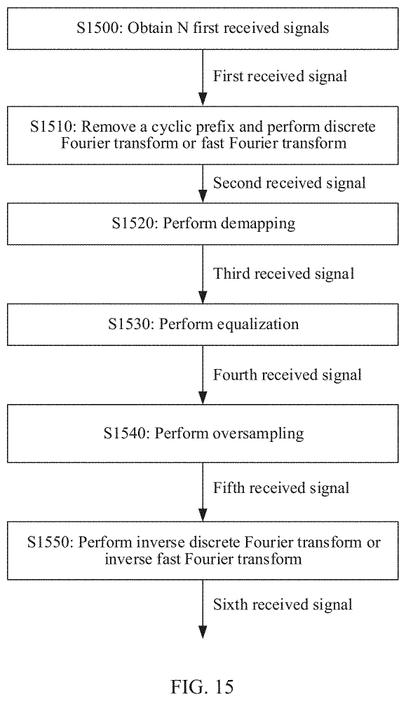

A main procedure and steps at a receive end corresponding to the transmit end in Embodiment 3 are shown in FIG. 15.

S1500: The receive end obtains N first received signals.

S1510: The receive end removes a CP based on the N first received signals, and performs DFT or FFT, to obtain N second received signals.

S1520: The receive end performs demapping based on the N second received signals, to obtain N third received signals.

In a possible implementation, frequency domain locations of signals obtained through the demapping are symmetrically placed along a center frequency. N frequency domain signals are obtained through the demapping.

S1530: The receive end performs equalization based on the N third received signals, to obtain N fourth received signals.

In a possible implementation, a manner in which the receive end performs equalization on the third received signal includes at least one of the following: a least squares method or a minimum mean-square error criterion.

S1540: The receive end performs oversampling based on the N fourth received signals, to obtain 2M fifth received signals.

In a possible implementation, the receive end performs oversampling on the N fourth received signals obtained through the matched filtering, that is, inserts 0 bits to a left side and a right side of each of the N fourth received signals, to obtain the 2M fourth received signals.

S1550: The receive end performs IDFT or IFFT based on the 2M fifth received signals, to obtain 2M sixth received signals.

In a possible implementation, the receive end extracts a signal based on the 2M sixth received signals in a data placement manner at the transmit end. For example, a real part is extracted from a signal at an odd-numbered index location, and an imaginary part is extracted from a signal at an even-numbered index location. Alternatively, a real part is extracted from a signal at an even-numbered index location, and an imaginary part is extracted from a signal at an odd-numbered index location.

It can be learned that the signal transmission method in Embodiment 3 expands a range of frequency domain shaping filtering, is not limited to processing of data obtained through the separation of a real part and an imaginary part, and includes processing of a signal in which a real part and an imaginary part are separated, and a pure real signal or a pure imaginary signal. In addition, a range of frequency domain shaping is related to a signal.

The foregoing describes the method in the embodiments of this application, and the following describes an apparatus in the embodiments of this application. The method and the apparatus are based on a same technical concept. Because a problem-solving principle of the method and that of the apparatus are similar, mutual reference may be made for implementation of the apparatus and the method, and repeated parts are not described again.

In the embodiments of this application, the apparatus may be divided into function modules based on the foregoing method examples. For example, function modules may be obtained through the division based on corresponding functions, or two or more functions may be integrated into one module. These modules may be implemented in a form of hardware or in a form of software function modules. It should be noted that the division into modules in the embodiments of this application is an example, is merely logical function division, and may be another division manner in specific implementation.

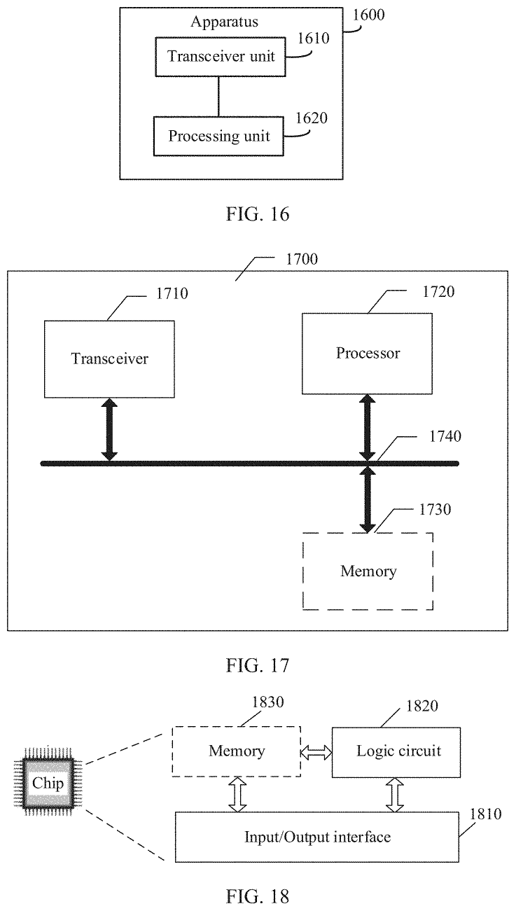

Based on a same technical concept as the foregoing method, FIG. 16 provides a schematic diagram of a structure of a signal transmission apparatus 1600 (the signal transmission apparatus may alternatively be regarded as a communication apparatus). The apparatus 1600 may be a transmit end or a chip or a functional unit applied to the transmit end, or may be a receive end or a chip or a functional unit applied to the receive end. The apparatus 1600 has any function of the transmit end in the foregoing method.

When the apparatus 1600 is configured to perform an operation performed by the transmit end, in a possible implementation, a transceiver unit 1610 and a processing unit 1620 may be further configured to perform the following steps in the foregoing method, for example:

The transceiver unit 1610 is configured to obtain 2M first to-be-sent signals.

The processing unit 1620 is configured to perform first generalized Fourier transform based on the 2M first to-be-sent signals, to obtain N second to-be-sent signals.

The processing unit 1620 is further configured to perform spectrum shaping based on the N second to-be-sent signals, to obtain N third to-be-sent signals.

The processing unit 1620 is further configured to perform first inverse generalized Fourier transform based on the N third to-be-sent signals, to obtain a first sent signal.

The transceiver unit 1610 is further configured to send the first sent signal.

M and N are positive integers, and 2M is greater than or equal to N.

In a possible implementation, the first generalized Fourier transform includes the following steps: The processing unit 1620 performs first phase shift based on the first to-be-sent signal, to obtain a fourth to-be-sent signal. Then, the processing unit 1620 performs discrete Fourier transform (DFT) or fast Fourier transform (FFT) based on the fourth to-be-sent signal, to obtain the second to-be-sent signal.

In a possible implementation, a value of the first phase shift satisfies the following formula:

$${e}^{\frac{- j π m α}{M}} ,$$

where α is 0.5 or −0.5, m∈[m₀, m₀+2M−1], m and m₀ are integers, M is a positive integer, and j=\sqrt{−1}.

In a possible implementation, the first inverse generalized Fourier transform includes the following steps: The processing unit 1620 performs inverse discrete Fourier transform (IDFT) or inverse fast Fourier transform (IFFT) based on the third to-be-sent signal, to obtain a fifth to-be-sent signal. Then, the processing unit 1620 performs second phase shift based on the fifth to-be-sent signal, to obtain the first sent signal.

In a possible implementation, a value of the second phase shift satisfies the following formula:

$${e}^{\frac{j π m α}{M}} ,$$

a value of the second phase shift is equal to 1, where
α is 0.5 or −0.5, m∈[m₀, m₀+2M−1], m and m₀ are integers, M is a positive integer, and j=\sqrt{−1}.

In a possible implementation, a value of m₀ is any one of 0, −M, or −M+1.

In a possible implementation, in the 2M first to-be-sent signals, a first to-be-sent signal with an odd sequence number includes only a real part signal, and a first to-be-sent signal with an even sequence number includes only an imaginary part signal. Alternatively, in the 2M first to-be-sent signals, a first to-be-sent signal with an even sequence number includes only a real part signal, and a first to-be-sent signal with an odd sequence number includes only an imaginary part signal. Alternatively, all the 2M first to-be-sent signals include only real part signals. Alternatively, all the 2M first to-be-sent signals include only imaginary part signals.

In a possible implementation, the spectrum shaping includes the following steps: The processing unit 1620 performs frequency domain shaping on the N second to-be-sent signals by using a filter whose filter length is N; multiplies, by a spectrum shaping coefficient A*P(k), the N second to-be-sent signals obtained through the frequency domain shaping, where k ∈ [k₀, k₀+N−1], k is a sequence number of a subcarrier, k₀ is a sequence number of a start location of the subcarrier, and A is a complex constant; and then, obtains the N third to-be-sent signals.

In a possible implementation, when all the 2M first to-be-sent signals include only real part signals, or when all the 2M first to-be-sent signals include only imaginary part signals, symmetry of P(k) is related to a value of α, and a relationship is shown as follows:

When α=0.5, N is an even number, M is an even number,

$${k}_{0} = - \frac{N - M}{2} + lM ,$$

and P(k) is conjugate symmetric about

$$k = - \frac{1 - M}{2} + lM ;$$

or N is an odd number, M is an odd number,

$${k}_{0} = - \frac{N - M}{2} + lM ,$$

and P(k) is conjugate symmetric about

$$k = - \frac{1 - M}{2} + lM .$$

When α=−0.5, N is an even number, M is an even number,

$${k}_{0} = - \frac{N - M}{2} - 1 + lM ,$$

and P(k) is conjugate symmetric about

$$k = \frac{1 + M}{2} + lM ;$$

or N is an odd number, M is an odd number,

$${k}_{0} = - \frac{N - M}{2} - 1 + lM ,$$

and P(k) is conjugate symmetric about

$$k = \frac{1 + M}{2} + lM .$$

l is an integer.

In other words, when all the 2M first to-be-sent signals include only real part signals, or when all the 2M first to-be-sent signals include only imaginary part signals, parity of N and parity of M are the same, that is, N and M are both odd numbers or even numbers.

In a possible implementation, when in the 2M first to-be-sent signals, a first to-be-sent signal with an odd sequence number includes only a real part signal, and a first to-be-sent signal with an even sequence number includes only an imaginary part signal, or when in the 2M first to-be-sent signals, a first to-be-sent signal with an even sequence number includes only a real part signal, and a first to-be-sent signal with an odd sequence number includes only an imaginary part signal, symmetry of P(k) is related to a value of α, and a relationship is shown as follows:

When α=0.5, N is an even number,

$${k}_{0} = - \frac{N}{2} + lM ,$$

and P(k) is conjugate symmetric about k=−½+lM.

When α=−0.5, N is an even number,

$${k}_{0} = - \frac{N}{2} - 1 + lM ,$$

and P(k) is conjugate symmetric about k=½+lM. l is an integer.

When the apparatus 1600 is configured to perform an operation performed by the transmit end, in another possible implementation, a transceiver unit 1610 and a processing unit 1620 may be further configured to perform the following steps in the foregoing method, for example:

The transceiver unit 1610 obtains 2M first to-be-sent signals. The processing unit 1620 performs DFT or FFT based on the 2M first to-be-sent signals, to obtain 2M second to-be-sent signals.

The processing unit 1620 performs spectrum shaping based on the 2M second to-be-sent signals, to obtain N third to-be-sent signals.

The processing unit 1620 performs subcarrier mapping based on the third to-be-sent signal, to obtain a fourth to-be-sent signal.

The processing unit 1620 performs IDFT or IFFT based on the fourth to-be-sent signal, and adds a CP, to obtain and send a first to-be-sent signal.

When the apparatus 1600 is configured to perform an operation performed by the receive end, in a possible implementation, a transceiver unit 1610 and a processing unit 1620 may be further configured to perform the following steps in the foregoing method, for example:

The transceiver unit 1610 is configured to obtain N first received signals.

The processing unit 1620 is configured to perform second generalized Fourier transform based on the N first received signals, to obtain N second received signals.

The processing unit 1620 is further configured to perform equalization based on the second received signal, to obtain a third received signal.

The processing unit 1620 is further configured to perform oversampling based on the third received signal, to obtain 2M fourth received signals.

The processing unit 1620 is further configured to perform second inverse generalized Fourier transform based on the 2M fourth received signals, to obtain a fifth received signal.

M and N are positive integers, and 2M is greater than or equal to N.

In a possible implementation, the second generalized Fourier transform includes the following steps: The processing unit 1620 performs third phase shift based on the first received signal, to obtain a sixth received signal. Then, the processing unit 1620 performs discrete Fourier transform DFT or fast Fourier transform FFT based on the sixth received signal, to obtain the second received signal.

In a possible implementation, a value of the third phase shift satisfies the following formula:

$${e}^{\frac{- j π m α}{M}} ,$$

or a value of the third phase shift is equal to 1, where α is 0.5 or −0.5, m∈[m₀, m₀+2M−1], m and m₀ are integers, M is a positive integer, and j=\sqrt{−1}.

In a possible implementation, the second inverse generalized Fourier transform includes the following steps: The processing unit 1620 performs inverse discrete Fourier transform IDFT or inverse fast Fourier transform IFFT based on the fourth received signal, to obtain a seventh received signal. Then, the processing unit 1620 performs fourth phase shift based on the seventh received signal, to obtain the fifth received signal.

In a possible implementation, a value of the fourth phase shift satisfies the following formula:

$${e}^{\frac{j π m α}{M}} ,$$

where α is 0.5 or −0.5, m∈[m₀, m₀+2M−1], m and m₀ are integers, M is a positive integer, and j=\sqrt{−1}.

In a possible implementation, a value of m₀ is any one of 0, −M, or −M+1.

In a possible implementation, a manner in which the processing unit 1620 performs equalization on the second received signal includes at least one of the following: a least squares method or a minimum mean-square error criterion.

When the apparatus 1600 is configured to perform an operation performed by the receive end, in another possible implementation, a transceiver unit 1610 and a processing unit 1620 may be further configured to perform the following steps in the foregoing method, for example:

The transceiver unit 1610 obtains N first received signals.

The processing unit 1620 removes a CP based on the N first received signals, and performs DFT or FFT, to obtain N second received signals.

The processing unit 1620 performs demapping based on the N second received signals, to obtain N third received signals.

The processing unit 1620 performs equalization based on the N third received signals, to obtain N fourth received signals.

The processing unit 1620 performs oversampling based on the N fourth received signals, to obtain 2M fifth received signals.

The processing unit 1620 performs IDFT or IFFT based on the 2M fifth received signals, to obtain 2M sixth received signals.

As shown in FIG. 17, an embodiment of this application further provides an apparatus 1700. The apparatus 1700 is configured to implement a function of a transmit end or a receive end in the foregoing method. The apparatus may be a transmit end or a receive end, an apparatus in the transmit end or the receive end, or an apparatus that can be used in matching with the transmit end or the receive end. The apparatus 1700 may be a chip system. In this embodiment of this application, the chip system may include a chip, or may include a chip and another discrete component. The apparatus 1700 includes at least one processor 1720, configured to implement a function of the transmit end or the receive end in the method provided in the embodiments of this application. The apparatus 1700 may further include a transceiver 1710.

The apparatus 1700 may be specifically configured to perform a related method performed by the transmit end in the foregoing method embodiments, for example:

The transceiver 1710 is configured to obtain 2M first to-be-sent signals.

The processor 1720 is configured to perform first generalized Fourier transform based on the 2M first to-be-sent signals, to obtain N second to-be-sent signals.

The processor 1720 is further configured to perform spectrum shaping based on the N second to-be-sent signals, to obtain N third to-be-sent signals.

The processor 1720 is further configured to perform first inverse generalized Fourier transform based on the N third to-be-sent signals, to obtain a first sent signal.

The transceiver 1710 is further configured to send the first sent signal.

M and N are positive integers, and 2M is greater than or equal to N.

In a possible implementation, the first generalized Fourier transform includes the following steps: The processor 1720 performs first phase shift based on the first to-be-sent signal, to obtain a fourth to-be-sent signal. Then, the processor 1720 performs discrete Fourier transform (DFT) or fast Fourier transform (FFT) based on the fourth to-be-sent signal, to obtain the second to-be-sent signal.

In a possible implementation, a value of the first phase shift satisfies the following formula:

$${e}^{\frac{- j π m α}{M}} ,$$

where α is 0.5 or −0.5, m∈[m₀, m₀+2M−1], m and m₀ are integers, M is a positive integer, and j=\sqrt{−1}.

In a possible implementation, the first inverse generalized Fourier transform includes the following steps: The processor 1720 performs inverse discrete Fourier transform (IDFT) or inverse fast Fourier transform (IFFT) based on the third to-be-sent signal, to obtain a fifth to-be-sent signal. Then, the processor 1720 performs second phase shift based on the fifth to-be-sent signal, to obtain the first sent signal.

In a possible implementation, a value of the second phase shift satisfies the following formula:

$${e}^{\frac{j π m α}{M}} ,$$

a value of the second phase shift is equal to 1, where
α is 0.5 or −0.5, m∈[m₀, m₀+2M−1], m and m₀ are integers, M is a positive integer, and j=\sqrt{−1}.

In a possible implementation, a value of m₀ is any one of 0, −M, or −M+1.

In a possible implementation, in the 2M first to-be-sent signals, a first to-be-sent signal with an odd sequence number includes only a real part signal, and a first to-be-sent signal with an even sequence number includes only an imaginary part signal. Alternatively, in the 2M first to-be-sent signals, a first to-be-sent signal with an even sequence number includes only a real part signal, and a first to-be-sent signal with an odd sequence number includes only an imaginary part signal. Alternatively, all the 2M first to-be-sent signals include only real part signals. Alternatively, all the 2M first to-be-sent signals include only imaginary part signals.

In a possible implementation, the spectrum shaping includes the following steps: The processor 1710 performs frequency domain shaping on the N second to-be-sent signals by using a filter whose filter length is N; multiplies, by a spectrum shaping coefficient A*P(k), the N second to-be-sent signals obtained through the frequency domain shaping, where k ∈ [k₀, k₀+N+1], k is a sequence number of a subcarrier, k₀ is a sequence number of a start location of the subcarrier, and A is a complex constant; and then, obtains the N third to-be-sent signals.

In a possible implementation, when all the 2M first to-be-sent signals include only real part signals, or when all the 2M first to-be-sent signals include only imaginary part signals, symmetry of P(k) is related to a value of α, and a relationship is shown as follows:

When α=0.5, N is an even number, M is an even number,

$${k}_{0} = - \frac{N - M}{2} + l M ,$$

and P(k) is conjugate symmetric about

$$k = - \frac{1 - M}{2} + l M ;$$

or N is an odd number, M is an odd number,

$${k}_{0} = - \frac{N - M}{2} + l M ,$$

and P(k) is conjugate symmetric about

$$k = - \frac{1 - M}{2} + l M .$$

When α=−0.5, N is an even number, M is an even number,

$${k}_{0} = - \frac{N - M}{2} - 1 + l M ,$$

and P(k) is conjugate symmetric about

$$k = \frac{1 + M}{2} + l M ;$$

or N is an odd number, M is an odd number,

$${k}_{0} = - \frac{N - M}{2} - 1 + l M ,$$

and P(k) is conjugate symmetric about

$$k = \frac{1 + M}{2} + l M .$$

l is an integer.

In other words, when all the 2M first to-be-sent signals include only real part signals, or when all the 2M first to-be-sent signals include only imaginary part signals, parity of N and parity of M are the same, that is, N and M are both odd numbers or even numbers.

In a possible implementation, when in the 2M first to-be-sent signals, a first to-be-sent signal with an odd sequence number includes only a real part signal, and a first to-be-sent signal with an even sequence number includes only an imaginary part signal, or when in the 2M first to-be-sent signals, a first to-be-sent signal with an even sequence number includes only a real part signal, and a first to-be-sent signal with an odd sequence number includes only an imaginary part signal, symmetry of P(k) is related to a value of α, and a relationship is shown as follows:

When α=0.5, N is an even number,

$${k}_{0} = - \frac{N}{2} + l M ,$$

and P(k) is conjugate symmetric about k=−½+lM.

When α=−0.5, N is an even number,

$${k}_{0} = - \frac{N}{2} - 1 + l M ,$$

and P(k) is conjugate symmetric about k=½+lM. l is an integer.

The apparatus 1700 may be specifically configured to perform a related method performed by the receive end in the foregoing method embodiments, for example:

The transceiver 1710 is configured to obtain N first received signals.

The processor 1720 is configured to perform second generalized Fourier transform based on the N first received signals, to obtain N second received signals.

The processor 1720 is further configured to perform equalization based on the second received signal, to obtain a third received signal.

The processor 1720 is further configured to perform oversampling based on the third received signal, to obtain 2M fourth received signals.

The processor 1720 is further configured to perform second inverse generalized Fourier transform based on the 2M fourth received signals, to obtain a fifth received signal.

M and N are positive integers, and 2M is greater than or equal to N.

In a possible implementation, the second generalized Fourier transform includes the following steps: The processor 1720 performs third phase shift based on the first received signal, to obtain a sixth received signal. Then, the processor 1720 performs discrete Fourier transform DFT or fast Fourier transform FFT based on the sixth received signal, to obtain the second received signal.

In a possible implementation, a value of the third phase shift satisfies the following formula:

$${e}^{\frac{- j π m α}{M}} ,$$

or a value of the third phase shift is equal to 1, where a is 0.5 or −0.5, m∈[m₀, m₀+2M−1], m and m₀ are integers, M is a positive integer, and j=\sqrt{−1}.

In a possible implementation, the second inverse generalized Fourier transform includes the following steps: The processor 1720 performs inverse discrete Fourier transform IDFT or inverse fast Fourier transform IFFT based on the fourth received signal, to obtain a seventh received signal. Then, the processor 1720 performs fourth phase shift based on the seventh received signal, to obtain the fifth received signal.

In a possible implementation, a value of the fourth phase shift satisfies the following formula:

$${e}^{\frac{j π m α}{M}} ,$$

where α is 0.5 or −0.5, m∈[m₀, m₀+2M−1], m and m₀ are integers, M is a positive integer, and j=\sqrt{−1}.

In a possible implementation, a value of m₀ is any one of 0, −M, or −M+1.

In a possible implementation, a manner in which the processor 1720 performs equalization on the second received signal includes at least one of the following: a least squares method or a minimum mean-square error criterion.

The apparatus 1700 may further include at least one memory 1730, configured to store program instructions and/or data. The memory 1730 is coupled to the processor 1720. Coupling in this embodiment of this application is indirect coupling or communication connection between apparatuses, units, or modules, and may be in an electrical, mechanical, or other form, and is used for information exchange between the apparatuses, units, or modules. The processor 1720 may cooperate with the memory 1730. The processor 1720 may execute the program instructions stored in the memory 1730. In a possible implementation, at least one of the at least one memory may be integrated with the processor. In another possible implementation, the memory 1730 is located outside the apparatus 1700.

A specific connection medium between the transceiver 1710, the processor 1720, and the memory 1730 is not limited in this embodiment of this application. In this embodiment of this application, in FIG. 17, the memory 1730, the processor 1720, and the transceiver 1710 are connected by using a bus 1740. The bus is represented by a thick line in FIG. 17. A connection manner between other components is merely an example for description, and is not limited thereto. The bus may be classified into an address bus, a data bus, a control bus, and the like. For ease of representation, only one thick line is used to represent the bus in FIG. 17, but this does not mean that there is only one bus or only one type of bus.

In this embodiment of this application, the processor 1720 may be one or more central processing units (CPU). When the processor 1720 is one CPU, the CPU may be a single-core CPU, or may be a multi-core CPU. The processor 1720 may be a general-purpose processor, a digital signal processor, an application-specific integrated circuit, a field programmable gate array or another programmable logic device, a discrete gate or a transistor logic device, or a discrete hardware component, and may implement or perform the methods, steps, and logical block diagrams disclosed in the embodiments of this application. The general-purpose processor may be a microprocessor, any conventional processor, or the like. The steps of the methods disclosed with reference to the embodiments of this application may be directly performed by a hardware processor, or may be performed by using a combination of hardware and software modules in the processor.

In this embodiment of this application, the memory 1730 may include but is not limited to a nonvolatile memory such as a hard disk drive (HDD) or a solid-state drive (SSD), a random access memory (RAM), an erasable programmable read-only memory (EPROM), a read-only memory (ROM), a portable read-only memory (CD-ROM), and the like. The memory is any other medium that can be configured to carry or store desired program code in a form of an instruction or a data structure and that can be accessed by a computer, but is not limited thereto. The memory in this embodiment of this application may alternatively be a circuit or any other apparatus that can implement a storage function, and is configured to store program instructions and/or data. The memory 1730 is used for related instructions and data.

As shown in FIG. 18, an embodiment of this application further provides an apparatus 1800. The apparatus 1800 may be configured to implement a function of the transmit end in the foregoing method. The apparatus 1800 may be a communication apparatus or a chip in the communication apparatus. The apparatus includes:
an input/output interface 1810, configured to obtain 2M first to-be-sent signals; and
a logic circuit 1820, configured to perform first generalized Fourier transform based on the 2M first to-be-sent signals, to obtain N second to-be-sent signals, where
the logic circuit 1820 is further configured to perform spectrum shaping based on the N second to-be-sent signals, to obtain N third to-be-sent signals;
the logic circuit 1820 is further configured to perform first inverse generalized Fourier transform based on the N third to-be-sent signals, to obtain a first sent signal;
the logic circuit 1820 is further configured to output the first sent signal; and
M and N are positive integers, and 2M is greater than or equal to N.

In a possible implementation, the first generalized Fourier transform includes the following steps: The logic circuit 1820 performs first phase shift based on the first to-be-sent signal, to obtain a fourth to-be-sent signal. Then, the logic circuit 1820 performs discrete Fourier transform (DFT) or fast Fourier transform (FFT) based on the fourth to-be-sent signal, to obtain the second to-be-sent signal.

In a possible implementation, a value of the first phase shift satisfies the following formula:

$${e}^{\frac{- j π m α}{M}} ,$$

where α is 0.5 or −0.5, m∈[m₀, m₀+2M−1], m and m₀ are integers, M is a positive integer, and j=\sqrt{−1}.

In a possible implementation, the first inverse generalized Fourier transform includes the following steps: The logic circuit 1820 performs inverse discrete Fourier transform (IDFT) or inverse fast Fourier transform (IFFT) based on the third to-be-sent signal, to obtain a fifth to-be-sent signal. Then, the logic circuit 1820 performs second phase shift based on the fifth to-be-sent signal, to obtain the first sent signal.

In a possible implementation, a value of the second phase shift satisfies the following formula:

$${e}^{\frac{j π m α}{M}} ,$$

a value of the second phase shift is equal to 1, where
α is 0.5 or −0.5, m∈[m₀, m₀+2M−1], m and m₀ are integers, M is a positive integer, and j=\sqrt{−1}.

In a possible implementation, a value of m₀ is any one of 0, −M, or −M+1.

In a possible implementation, in the 2M first to-be-sent signals, a first to-be-sent signal with an odd sequence number includes only a real part signal, and a first to-be-sent signal with an even sequence number includes only an imaginary part signal. Alternatively, in the 2M first to-be-sent signals, a first to-be-sent signal with an even sequence number includes only a real part signal, and a first to-be-sent signal with an odd sequence number includes only an imaginary part signal. Alternatively, all the 2M first to-be-sent signals include only real part signals. Alternatively, all the 2M first to-be-sent signals include only imaginary part signals.

In a possible implementation, the spectrum shaping includes the following steps: The logic circuit 1820 performs frequency domain shaping on the N second to-be-sent signals by using a filter whose filter length is N; multiplies, by a spectrum shaping coefficient A*P(k), the N second to-be-sent signals obtained through the frequency domain shaping, where k ∈ [k₀, k₀+N−1], k is a sequence number of a subcarrier, k₀ is a sequence number of a start location of the subcarrier, and A is a complex constant; and then, obtains the N third to-be-sent signals.

In a possible implementation, when all the 2M first to-be-sent signals include only real part signals, or when all the 2M first to-be-sent signals include only imaginary part signals, symmetry of P(k) is related to a value of α, and a relationship is shown as follows:

When α=0.5, N is an even number, M is an even number,

$${k}_{0} = - \frac{N - M}{2} + lM ,$$

and P(k) is conjugate symmetric about

$$k = - \frac{1 - M}{2} + lM ;$$

or N is an odd number, M is an odd number,

$${k}_{0} = - \frac{N - M}{2} + lM ,$$

and P(k) is conjugate symmetric about

$$k = - \frac{1 - M}{2} + lM .$$

When α=−0.5, N is an even number, M is an even number,

$${k}_{0} = - \frac{N - M}{2} - 1 + lM ,$$

and P(k) is conjugate symmetric about

$$k = \frac{1 + M}{2} + lM ;$$

or N is an odd number, M is an odd number,

$${k}_{0} = - \frac{N - M}{2} - 1 + lM ,$$

and P(k) is conjugate symmetric about

$$k = \frac{1 + M}{2} + lM .$$

l is an integer.

In other words, when all the 2M first to-be-sent signals include only real part signals, or when all the 2M first to-be-sent signals include only imaginary part signals, parity of N and parity of M are the same, that is, N and M are both odd numbers or even numbers.

In a possible implementation, when in the 2M first to-be-sent signals, a first to-be-sent signal with an odd sequence number includes only a real part signal, and a first to-be-sent signal with an even sequence number includes only an imaginary part signal, or when in the 2M first to-be-sent signals, a first to-be-sent signal with an even sequence number includes only a real part signal, and a first to-be-sent signal with an odd sequence number includes only an imaginary part signal, symmetry of P(k) is related to a value of α, and a relationship is shown as follows:

When α=0.5, N is an even number,

$${k}_{0} = - \frac{N}{2} + lM ,$$

and P(k) is conjugate symmetric about k=−½+lm.

When α=−0.5, N is an even number,

$${k}_{0} = - \frac{N}{2} - 1 + lM ,$$

and P(k) is conjugate symmetric about k=½+lM. l is an integer.

The apparatus 1800 may be further configured to implement a function of the receive end in the foregoing method. The apparatus 1800 may be a communication apparatus or a chip in the communication apparatus. The apparatus includes:
an input/output interface 1810, configured to obtain N first received signals; and
a logic circuit 1820, configured to perform second generalized Fourier transform based on the N first received signals, to obtain N second received signals, where
the logic circuit 1820 is further configured to perform equalization based on the second received signal, to obtain a third received signal;
the logic circuit 1820 is further configured to perform oversampling based on the third received signal, to obtain 2M fourth received signals;
the logic circuit 1820 is further configured to perform second inverse generalized Fourier transform based on the 2M fourth received signals, to obtain a fifth received signal; and
M and N are positive integers, and 2M is greater than or equal to N.

In a possible implementation, the second generalized Fourier transform includes the following steps: The logic circuit 1820 performs third phase shift based on the first received signal, to obtain a sixth received signal. Then, the logic circuit 1820 performs discrete Fourier transform DFT or fast Fourier transform FFT based on the sixth received signal, to obtain the second received signal.

In a possible implementation, a value of the third phase shift satisfies the following formula:

$${e}^{\frac{- j π m α}{M}} ,$$

or a value of the third phase shift is equal to 1, where α is 0.5 or −0.5, m∈[m₀, m₀+2M−1], m and m₀ are integers, M is a positive integer, and j=\sqrt{−1}.

In a possible implementation, the second inverse generalized Fourier transform includes the following steps: The logic circuit 1820 performs inverse discrete Fourier transform IDFT or inverse fast Fourier transform IFFT based on the fourth received signal, to obtain a seventh received signal. Then, the logic circuit 1820 performs fourth phase shift based on the seventh received signal, to obtain the fifth received signal.

In a possible implementation, a value of the fourth phase shift satisfies the following formula:

$${e}^{\frac{j π m α}{M}} ,$$

where α is 0.5 or −0.5, m∈[m₀, m₀+2M−1], m and m₀ are integers, M is a positive integer, and j=\sqrt{−1}.

In a possible implementation, a value of m₀ is any one of 0, −M, or −M+1.

In a possible implementation, a manner in which the logic circuit 1820 performs equalization on the second received signal includes at least one of the following: a least squares method or a minimum mean-square error criterion.

When the communication apparatus is a chip applied to a terminal device, the terminal device chip implements a function of the terminal device in the foregoing method embodiment. The terminal device chip receives information from another module (for example, a radio frequency module or an antenna) in the terminal device, and the information is sent by a network device to the terminal device. Alternatively, the terminal device chip sends information to another module (for example, a radio frequency module or an antenna) in the terminal device, and the information is sent by the terminal device to a network device.

When the communication apparatus is a chip applied to a network device, the network device chip implements a function of the network device in the foregoing method embodiment. The network device chip receives information from another module (for example, a radio frequency module or an antenna) in the network device, and the information is sent by a terminal device to the network device. Alternatively, the network device chip sends information to another module (for example, a radio frequency module or an antenna) in the network device, and the information is sent by the network device to a terminal device.

Based on a same concept as the foregoing method embodiments, an embodiment of this application further provides a computer-readable storage medium. The computer-readable storage medium stores a computer program, and the computer program is executed by hardware (for example, a processor), to implement some or all steps of any method performed by any apparatus in the embodiments of this application.

Based on a same concept as the foregoing method embodiments, an embodiment of this application further provides a computer program product including instructions. When the computer program product runs on a computer, the computer is enabled to perform some or all steps of any method in the foregoing aspects.

Based on a same concept as the foregoing method embodiments, this application further provides a chip or a chip system. The chip may include a processor. The chip may further include a memory (or a storage module) and/or a transceiver (or a communication module), or the chip is coupled to the memory (or the storage module) and/or the transceiver (or the communication module). The transceiver (or the communication module) may be configured to support the chip in performing wired and/or wireless communication. The memory (or the storage module) may be configured to store a program. The processor may invoke the program to implement an operation performed by the terminal or the network device in any one of the foregoing method embodiments or possible implementations of the method embodiments. The chip system may include the foregoing chip, or may include the foregoing chip and another discrete component, such as a memory (or a storage module) and/or a transceiver (or a communication module).

Based on a same concept as that in the foregoing method embodiment, this application further provides a communication system. The communication system may include the foregoing terminal and/or network device. The communication system may be configured to implement an operation performed by the terminal or the network device in any one of the foregoing method embodiments or possible implementations of the method embodiments. For example, the communication system may have a structure shown in FIG. 1.

All or some of the foregoing embodiments may be implemented by using software, hardware, firmware, or any combination thereof. When software is used to implement the embodiments, all or some of the embodiments may be implemented in a form of a computer program product. The computer program product includes one or more computer instructions. When computer program instructions are loaded and executed on a computer, all or some of procedures or functions according to the embodiments of this application are generated. The computer may be a general-purpose computer, a special-purpose computer, a computer network, or another programmable apparatus. The computer instructions may be stored in a computer-readable storage medium, or transmitted from one computer-readable storage medium to another computer-readable storage medium. For example, the computer instructions may be transmitted from one website site, computer, server, or data center to another website site, computer, server, or data center in a wired (for example, a coaxial cable, an optical fiber, or a digital subscriber line) or wireless (for example, infrared, radio, or microwave) manner. The computer-readable storage medium may be any usable medium that can be accessed by a computer, or a data storage device such as a server or a data center that integrates one or more usable media. The usable medium may be a magnetic medium (for example, a floppy disk, a hard disk, or a magnetic tape), an optical medium (for example, an optical disc), a semiconductor medium (for example, a solid state disk), or the like. In the foregoing embodiments, descriptions of each embodiment have different emphasis. For a part that is not described in detail in an embodiment, reference may be made to related descriptions in another embodiment.

In the foregoing embodiments, descriptions of each embodiment have different emphasis. For a part that is not described in detail in an embodiment, reference may be made to related descriptions in another embodiment.

In the several embodiments provided in this application, it should be understood that the disclosed apparatus may also be implemented in another manner. For example, the apparatus embodiments described above are merely examples. For example, division into units is merely logical function division, and may be another division manner in actual implementation. For example, a plurality of units or components may be combined or integrated into another system, or some features may be ignored or not performed. In addition, the displayed or discussed indirect coupling, direct coupling, or communication connection may be through some interfaces, and the indirect coupling or communication connection between the apparatuses or units may be in electrical or other forms.

The units described as separate parts may or may not be physically separated, and parts displayed as units may or may not be physical units, that is, may be located in one place, or may be distributed on a plurality of network units. Some or all of the units may be selected according to actual requirements to achieve the objectives of the solutions in the embodiments.

If the integrated unit is implemented in a form of a software function unit and is sold or used as an independent product, the integrated unit may be stored in a computer-readable storage medium. Based on the understanding, the technical solutions of this application essentially, or a part that contributes to the prior art, or all or some of the technical solutions may be embodied in a form of a software product. The computer software product is stored in a storage medium. Several instructions are included to instruct a computer device (which may be a personal computer, a server, a network device, or the like) to perform all or some of the steps of the methods in the embodiments of this application.

The foregoing descriptions are merely some specific implementations of this application, but the protection scope of this application is not limited thereto. Any person skilled in the art may make other changes or modifications to these embodiments within the technical scope disclosed in this application. Therefore, the appended claims are intended to be construed as including the embodiments described above and as changes and modifications that fall within the scope of the present application. Therefore, the protection scope of this application shall be subject to the protection scope of the claims.

What is claimed is:

1. A method, comprising:
obtaining, by a transmit end, 2M first to-be-sent signals;
performing, by the transmit end, first generalized Fourier transform based on the 2M first to-be-sent signals, to obtain N second to-be-sent signals;
performing, by the transmit end, spectrum shaping based on the N second to-be-sent signals, to obtain N third to-be-sent signals; and
performing, by the transmit end, first inverse generalized Fourier transform based on the N third to-be-sent signals, to obtain and send a first sent signal, wherein
M and N are positive integers, and 2M is greater than or equal to N.

2. The method according to claim 1, wherein the first generalized Fourier transform comprises:
performing, by the transmit end, first phase shift based on the 2M first to-be-sent signals, to obtain a fourth to-be-sent signal; and
performing, by the transmit end, either discrete Fourier transform (DFT) or fast Fourier transform (FFT) based on the fourth to-be-sent signal, to obtain the N second to-be-sent signals.

3. The method according to claim 2, wherein a value of the first phase shift satisfies the following formula:
$${e}^{\frac{- j π m α}{M}} ,$$
wherein
α is 0.5 or −0.5, m∈[m₀, m₀+2M−1], m and m₀ are integers, M is a positive integer, and j=\sqrt{−1}.

4. The method according to claim 1, wherein the first inverse generalized Fourier transform comprises:
performing, by the transmit end, either inverse discrete Fourier transform (IDFT) or inverse fast Fourier transform (IFFT) based on the N third to-be-sent signals, to obtain a fifth to-be-sent signal; and
performing, by the transmit end, second phase shift based on the fifth to-be-sent signal, to obtain the first sent signal.

5. The method according to claim 4, wherein
a value of the second phase shift satisfies the following formula:
$${e}^{\frac{j π m α}{M}} ,$$
or
the value of the second phase shift is equal to 1, wherein
α is 0.5 or −0.5, m∈[m₀, m₀+2M−1], m and m₀ are integers, M is a positive integer, and j=\sqrt{−1}.

6. The method according to claim 5, wherein m₀ is 0, −M, or −M+1.

7. The method according to claim 1, wherein at least one of following conditions is satisfied:
in the 2M first to-be-sent signals, a first to-be-sent signal with an odd sequence number comprises only a real part signal, and a first to-be-sent signal with an even sequence number comprises only an imaginary part signal;
in the 2M first to-be-sent signals, a first to-be-sent signal with an even sequence number comprises only a real part signal, and a first to-be-sent signal with an odd sequence number comprises only an imaginary part signal;
all the 2M first to-be-sent signals comprise only real part signals; or
all the 2M first to-be-sent signals comprise only imaginary part signals.

8. The method according to claim 1, wherein the spectrum shaping comprises:
performing, by the transmit end, frequency domain shaping on the N second to-be-sent signals by using a filter whose filter length is N;
multiplying the N second to-be-sent signals by a spectrum shaping coefficient A*P(k), wherein k ∈ [k₀, k₀+N−1], k is a sequence number of a subcarrier, k₀ is a sequence number of a start location of the subcarrier, and A is a complex constant; and
obtaining the N third to-be-sent signals.

9. The method according to claim 8, wherein when all the 2M first to-be-sent signals comprise only real part signals, or when all the 2M first to-be-sent signals comprise only imaginary part signals, symmetry of P(k) is related to a value of α in one of the following ways:
when α=0.5,
either N is an even number, M is an even number,
$${k}_{0} = - \frac{N - M}{2} + lM ,$$
and P(k) is conjugate symmetric about
$$k = - \frac{1 - M}{2} + lM ;$$
or
N is an odd number, M is an odd number,
$${k}_{0} = - \frac{N - M}{2} + lM ,$$
and P(k) is conjugate symmetric about
$$k = - \frac{1 - M}{2} + lM ;$$
or
when α=−0.5,
either N is an even number, M is an even number,
$${k}_{0} = - \frac{N - M}{2} - 1 + lM ,$$
and P(k) is conjugate symmetric about
$$k = \frac{1 + M}{2} + lM ;$$
or
N is an odd number, M is an odd number,
$${k}_{0} = - \frac{N - M}{2} - 1 + lM ,$$
and P(k) is conjugate symmetric about
$$k = \frac{1 + M}{2} + lM ,$$
wherein
l is an integer.

10. The method according to claim 8, wherein when in the 2M first to-be-sent signals, a first to-be-sent signal with an odd sequence number comprises only a real part signal, and a first to-be-sent signal with an even sequence number comprises only an imaginary part signal, or when in the 2M first to-be-sent signals, a first to-be-sent signal with an even sequence number comprises only a real part signal, and a first to-be-sent signal with an odd sequence number comprises only an imaginary part signal, symmetry of P(k) is related to a value of α in one of the following ways:
when α=0.5,
N is an even number,
$${k}_{0} = - \frac{N}{2} + lM ,$$
and P(k) is conjugate symmetric about k=−½+lM; or
when α=−0.5,
N is an even number,
$${k}_{0} = - \frac{N}{2} - 1 + lM ,$$
and P(k) is conjugate symmetric about k=½+lM, wherein
l is an integer.

11. A method, comprising:
obtaining, by a receive end, N first received signals;
performing, by the receive end, second generalized Fourier transform based on the N first received signals, to obtain N second received signals;
performing, by the receive end, equalization based on the N second received signals, to obtain a third received signal;
performing, by the receive end, oversampling based on the third received signal, to obtain 2M fourth received signals; and
performing, by the receive end, second inverse generalized Fourier transform based on the 2M fourth received signals, to obtain a fifth received signal, wherein
M and N are positive integers, and 2M is greater than or equal to N.

12. The method according to claim 11, wherein the second generalized Fourier transform comprises:
performing, by the receive end, third phase shift based on the N first received signals, to obtain a sixth received signal; and
performing, by the receive end, either discrete Fourier transform (DFT) or fast Fourier transform (FFT) based on the sixth received signal, to obtain the N second received signals.

13. The method according to claim 12, wherein
a value of the third phase shift satisfies the following formula:
$${e}^{\frac{- j π m α}{M}} ,$$
or
the value of the third phase shift is equal to 1, wherein
α is 0.5 or −0.5, m∈[m₀, m₀+2M−1], m and m₀ are integers, M is a positive integer, and j=\sqrt{−1}.

14. The method according to claim 11, wherein the second inverse generalized Fourier transform comprises:
performing, by the receive end, either inverse discrete Fourier transform (IDFT) or inverse fast Fourier transform (IFFT) based on the 2M fourth received signals, to obtain a seventh received signal; and
performing, by the receive end, fourth phase shift based on the seventh received signal, to obtain the fifth received signal.

15. The method according to claim 14, wherein a value of the fourth phase shift satisfies the following formula:
$${e}^{\frac{j π m α}{M}} ,$$
wherein
α is 0.5 or −0.5, m∈[m₀, m₀+2M−1], m and m₀ are integers, M is a positive integer, and j=\sqrt{−1}.

16. The method according to claim 15, wherein m₀ is 0, −M, or −M+1.

17. The method according to claim 11, wherein a manner in which the receive end performs equalization on the N second received signals comprises at least one of the following: a least squares method or a minimum mean-square error criterion.

18. An apparatus, comprising a transceiver, at least one processor, and at least one memory coupled to the at least one processor and storing programming instructions for execution by the at least one processor to cause the apparatus to:
obtain 2M first to-be-sent signals;
perform first generalized Fourier transform based on the 2M first to-be-sent signals, to obtain N second to-be-sent signals;
perform spectrum shaping based on the N second to-be-sent signals, to obtain N third to-be-sent signals;
perform first inverse generalized Fourier transform based on the N third to-be-sent signals, to obtain a first sent signal; and
send the first sent signal, wherein
M and N are positive integers, and 2M is greater than or equal to N.

19. The apparatus according to claim 18, wherein the first generalized Fourier transform comprises:
performing first phase shift based on the 2M first to-be-sent signals, to obtain a fourth to-be-sent signal; and
performing either discrete Fourier transform (DFT) or fast Fourier transform (FFT) based on the fourth to-be-sent signal, to obtain the N second to-be-sent signals.

20. The apparatus according to claim 19, wherein a value of the first phase shift satisfies the following formula:
$${e}^{\frac{- j π m α}{M}} ,$$
wherein
α is 0.5 or −0.5, m∈[m₀, m₀+2M−1], m and m₀ are integers, M is a positive integer, and j=\sqrt{−1}.
